(19) United States
(12) Patent Application Publication
(10) Pub. No.: US 2011/0273737 A1
(43) Pub. Date: Nov. 10, 2011

(54) INFORMATION PROCESSING APPARATUS, IMAGE FORMING APPARATUS MANAGEMENT METHOD, AND PROGRAM

(75) Inventor: Toyomi Hirao, Kawasaki-shi (JP)

(73) Assignee: CANON KABUSHIKI KAISHA, Tokyo (JP)

(21) Appl. No.: 13/100,524

(22) Filed: May 4, 2011

(30) Foreign Application Priority Data
May 7, 2010 (JP) 2010-107411

(51) Int. Cl. G06K 15/02

(52) U.S. Cl. 358/1.14

(57) ABSTRACT

An information processing apparatus manages an upper limit value of the number of licenses that can be issued to total multifunction peripheral (MFP)s provided within the system and the number of already issued licenses. If a request for issuing a license that permits the execution of a job has been received from the MFP, the information processing apparatus executes control for issuing the license if the number of already issued licenses does not exceed the upper limit value of the number of licenses that can be issued, when the license is issued. On the other hand, if it is determined that the number of already issued licenses exceeds the upper limit value of the number of licenses that can be issued, the information processing apparatus executes control for issuing no license.

### BACKGROUND OF THE INVENTION

1. Field of the Invention

The present invention relates to an information processing apparatus, an image forming apparatus management method, and a program.

2. Description of the Related Art

In recent years, a plurality of image forming apparatuses has been typically connected to a network in a network environment. However, if a plurality of image forming apparatuses connected to the network has been powered on at the same time, the total power consumption may increase.

In order to solve the above-described problem, a method discussed in Japanese Patent Application Laid-Open No. 2005-173690 restricts the number of image forming apparatuses that can be powered on at the same time within a specific time period based on a past job execution history. However, because a server provided in the above-described conventional method centrally manages a state of power supply to each image forming apparatus, a user of an image forming apparatus that has been powered off is required to wait until the image forming apparatus is powered on by the server. Accordingly, in the above-described conventional method, a user convenience cannot be achieved.

### SUMMARY OF THE INVENTION

The present invention is directed to a method capable of allowing a user of an image forming apparatus to execute a print job on an appropriate image forming apparatus desired by the user while restricting and suppressing an effect on the environment from image forming apparatuses that simultaneously execute different jobs.

According to an aspect of the present invention, an information processing apparatus configured to manage execution of a job by a plurality of image forming apparatuses includes a license issuance processing unit configured, according to a request for issuing a license for permitting the execution of the job, which is transmitted from the image forming apparatus in executing the job on the image forming apparatus, to issue the license to the image forming apparatus, a management unit configured to store and manage an upper limit value of a number of licenses that can be issued to the total image forming apparatuses and the number of licenses that have been already issued, and a license returning processing unit configured to subtract the number of already issued licenses, which is managed by the management unit, according to a request for returning the license transmitted from the image forming apparatus that has completed the job. In the information processing apparatus, the license issuance processing unit is configured to execute control for issuing the license if the number of already issued licenses does not exceed the upper limit value of the number of licenses that can be issued, and to execute control for issuing no license if the number of already issued licenses exceeds the upper limit value for the number of licenses that can be issued.

According to an aspect of the present invention, jobs executed by a plurality of image forming apparatuses can be efficiently managed without degrading the user convenience. In addition, an effect (for example, the increase in the energy consumption, such as the power consumption, and the increase in the amount of emitted CO₂) from all the image forming apparatuses on the environment can be suppressed.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the present invention.

FIGS. 1A and 1B illustrate an exemplary configuration of an image forming system to which an information processing apparatus according to the present invention can be applied.

FIGS. 2A through 2C illustrate an example of a license calculation table, a license request return packet, and a license packet, respectively.

FIG. 3 illustrates an example of a screen for determining the number of licenses.

FIGS. 4A through 4C illustrate an example of a license quantity table, a job execution time prediction table, and a license management table, respectively.

FIG. 5 is a flow chart illustrating an example of license issuing processing.

FIG. 6 is a flow chart illustrating an example of license returning processing.

FIGS. 7A and 7B illustrate an exemplary inner configuration of a multifunction peripheral (MFP), an example of shifting of power control states, and an exemplary feeding point.

FIG. 8 is a flow chart illustrating an example of power control.

FIG. 9 is a flow chart illustrating an example of job execution processing.

FIGS. 10A and 10B illustrate an example of a screen for executing a setting for an expired license.

FIG. 11 illustrates an example of a license request return packet.

FIG. 12 is a flow chart illustrating an example of license extension request processing.

FIG. 13 is a flow chart illustrating an example of job execution processing.

FIG. 14 is a flow chart illustrating an example of processing executed for an expired license.

FIG. 15A illustrates an exemplary functional configuration of a server computer. FIG. 15B illustrates an example of a screen for determining a maximum value of the number of licenses that can be issued.

FIGS. 16A and 16B illustrate an example of a license quantity table and a license management table, respectively.

FIG. 17 is a flow chart illustrating an example of license quantity automatic setting processing.

FIG. 18 is a flow chart illustrating an example of license issuing processing.

FIG. 19 is a flow chart illustrating an example of license quantity automatic adjustment processing.

FIG. 20 is a flow chart illustrating an example of divided job-execution processing.

FIGS. 21A through 21C illustrate a divided job table, a license packet, and a license request return packet transmitted when a job is divided.

FIG. 22 is a flow chart illustrating an example of power control.

FIG. 23 is a flow chart illustrating an example of division execution processing.

FIG. 24 is a flow chart illustrating an example of license issuing processing.

FIG. 25 illustrates an example of a screen for managing the type of a job executed under a special license.

### DESCRIPTION OF THE EMBODIMENTS

Various exemplary embodiments, features, and aspects of the invention will be described in detail below with reference to the drawings.

A first exemplary embodiment of the present invention will now be described below. In the following description of the present exemplary embodiment, it is supposed that a plurality of MFPs, each of which is an image forming apparatus, and one management apparatus exist on a network. However, the present invention is not limited to this. More specifically, only one MFP can be provided on the network. Furthermore, a plurality of management apparatuses can exist on the same network.

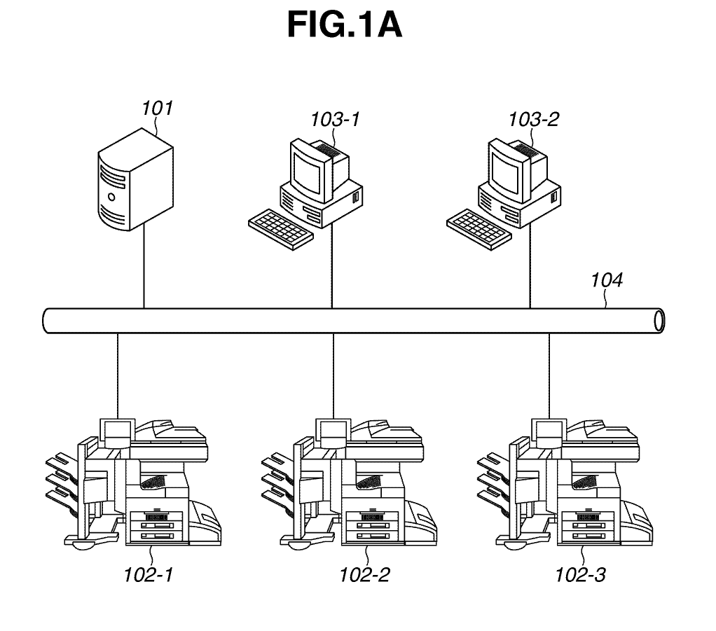

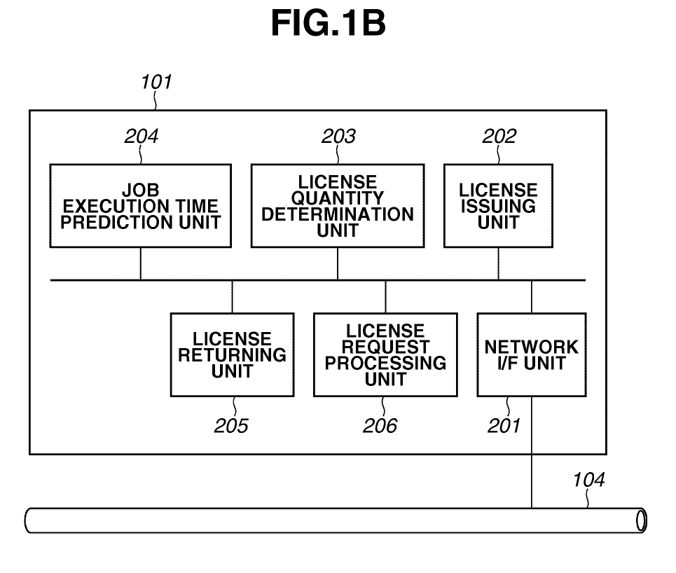

FIG. 1A illustrates an exemplary configuration of an image forming system to which an information processing apparatus according to the present invention can be applied. Referring to FIG. 1A, a server computer (hereinafter simply referred to as an “SC”) 101 is a management apparatus (an example of the information processing apparatus according to the present invention). Each of MFPs 102-1 through 102-3 is an image forming apparatus.

Each of the MFPs 102-1 through 102-3 has various functions, such as a reading function, a printing function, an electronic image generation function, and a post-processing function. To paraphrase this, each of the MFPs 102-1 through 102-3 has various processing blocks, such as a reading unit, a printer unit, an image processing unit, and a post-processing unit. In addition, the MFPs 102-1 through 102-3 include a user interface (operation unit). The operation unit is constituted by a liquid crystal display (LCD) touch panel, via which a user can instruct a copy operation or the generation of electronic data.

Client computers 103-1 through 103-2 input a print job to the MFPs 102-1 through 102-3. The SC 101, the MFPs 102-1 through 102-3 (the MFPs 102-1 through 102-3 may be collectively referred to below as the MFP 102), and the client computers 103-1 and 103-2 (hereinbelow, the client computers 103-1 and 103-2 are collectively referred to as the client computer 103) are in communication with one another via a network 104 (hereinafter simply referred to as an “NW 104”).

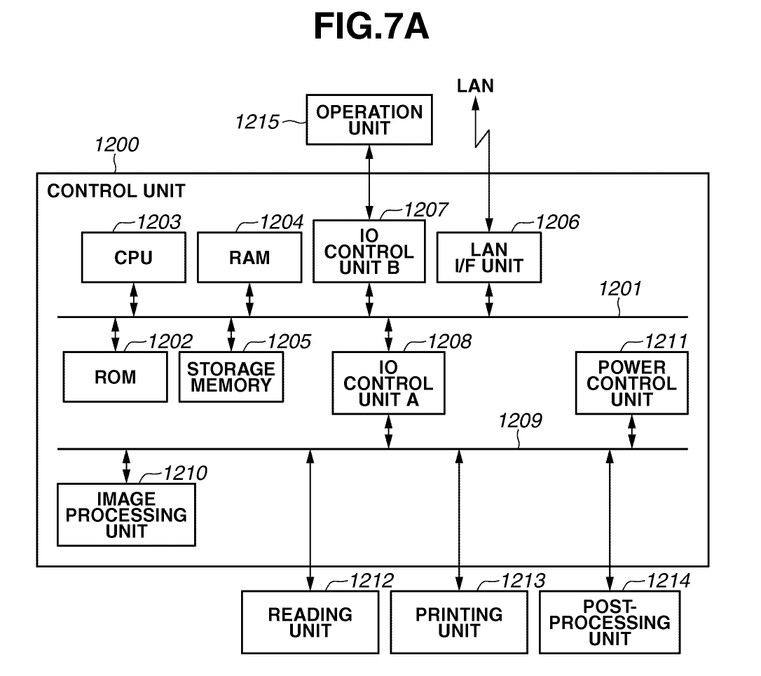

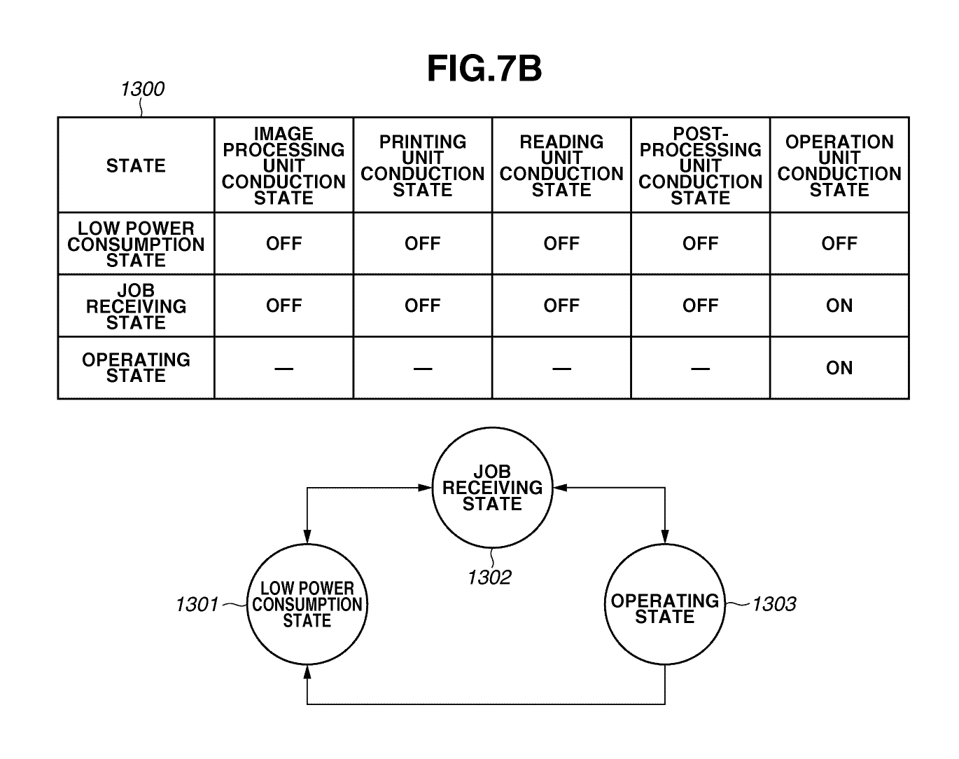

If no job execution request has been input by a user yet, the MFP 102 maintains a low power state 1301 (to be described in detail below with reference to FIG. 7B). In the low power state 1301, power is not supplied to any processing block. On the other hand, if a print job execution instruction has been input by the client computer 103 or if the restoration from the low power state 1301 has been input via a user interface of the MFP itself, the MFP 102 shifts to a job receiving state 1302 (FIG. 7B).

After shifting to the job receiving state 1302, the MFP 102 requests the SC 101 to give (issue) a license to the MFP 102. According to whether the requested license has been given (i.e., if the license has been appropriately given as requested), the MFP 102 shifts to an operating state 1303 (FIG. 7B). Then the MFP 102 supplies power to each processing block. After the job is completely executed, the MFP 102 discontinues the power supply to each processing block and then shifts to the low power state 1301 again.

FIG. 1B illustrates an exemplary functional configuration of the SC 101 according to the present exemplary embodiment. Referring to FIG. 1B, the SC 101 includes functional units 201 through 206. The functional units 201 through 206 are implemented by a central processing unit (CPU) of the SC 101 by reading and executing a program recorded on an external memory of the SC 101 as a computer-executable program.

The functional units of the SC 101 include the network interface (I/F) unit 201. A license request and the issuance of a license requested by an MFP 102 on the NW 104 are executed via the network I/F unit 201. In addition, the SC 101 includes the license issuing unit 202, the license quantity determination unit 203, the job execution time prediction unit 204, the license returning unit 205, and the license request processing unit 206.

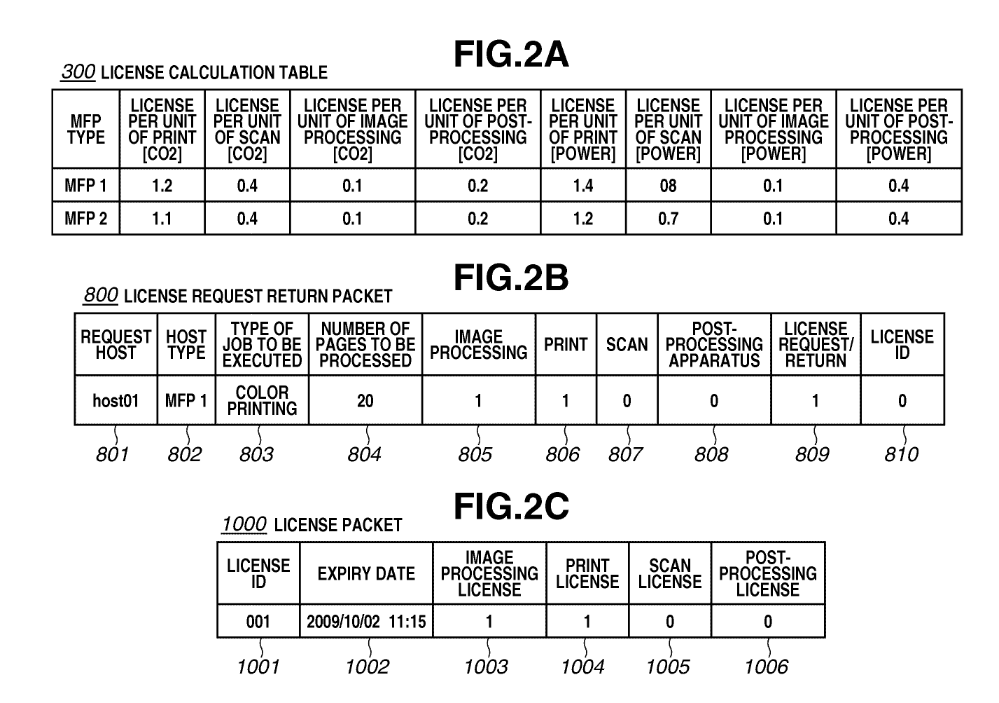

The license request processing unit 206 issues a license and manages the number of licenses by using each of the functional units 201 through 205. More specifically, the license request processing unit 206 gives (issues) a license when a license request return packet 800 (FIG. 2B), which is transmitted from the MFP 102, is received.

The license issuing unit 202 issues a license according to a license issuing instruction, which is given by the license request processing unit 206. The license returning unit 205 executes processing for returning a license, which is to be returned from the MFP 102.

The license quantity determination unit 203 will be described in detail. The license quantity determination unit 203 determines the maximum number of licenses (a “license maximum value”, which is an upper limit value of the number of licenses that can be given in total by the MFPs 102-1 through 102-3 (i.e., in total of a plurality of image forming apparatuses)) that can be given according to a form of license, which is previously set on the SC 101.

Alternatively, the license maximum value can be determined according to the degree of an effect caused by the amount of carbon dioxide emitted within unit time (hereinafter simply referred to as the amount of emitted CO₂) or by the power consumption, on the environment, which can be used as the reference. Further, alternatively, the license maximum value can be determined according to the maximum number of MFPs or processing blocks that can operate at the same time within the system, which can be used as the reference. The processing block will be described in detail below.

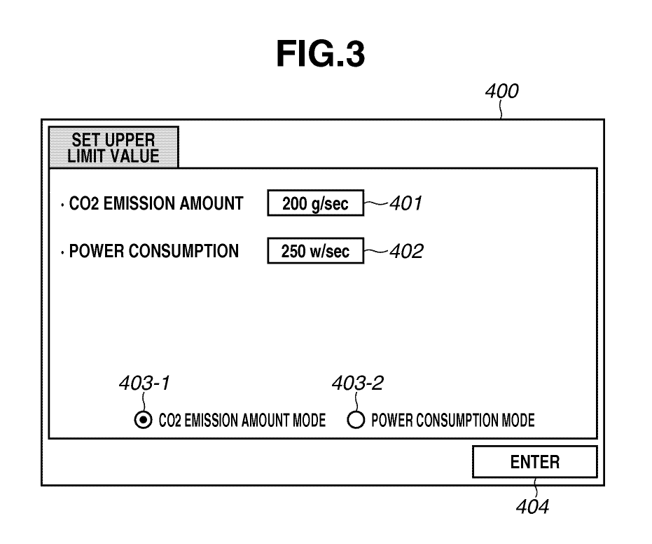

In addition, the license maximum value can be adjusted also according to other parameters, such as costs for developers or the like. In the present exemplary embodiment, the license maximum value can be determined according to the amount of emitted CO₂ or the power consumption per unit time. A method for determining the license maximum value will be described in detail below with reference to FIG. 3.

In addition, the license quantity determination unit 203 generates a license calculation table 300 (FIG. 2A) and stores the generated license calculation table 300 on a random access memory (RAM) of the SC 101. The license calculation table 300 (FIG. 2A) is generated in the following manner.

At first, the license quantity determination unit 203 acquires information about the CO₂ emission amount (g/sec) and the power consumption (w/sec) per unit time when a job is executed, for each type (model) of the MFP 102 connected to the NW 104 and for each processing block used in executing the job. The information can be previously set by a user (administrator) to the external memory of the SC 101. Alternatively, the information can be acquired from each of the MFPs 102 via the NW 104.

Furthermore, the license quantity determination unit 203 generates the license calculation table 300 (FIG. 2A) according to the acquired information. The generated license calculation table 300 is stored on the RAM of the SC 101.

In the present exemplary embodiment, the above-described processing block includes a printer unit 1213, a reading unit 1212, an image processing unit 1210, and a post-processing unit 1214 of the MFP (image forming apparatus) 102, which will be described in detail below. However, the processing block according to the present exemplary embodiment can also include other processing blocks.

FIG. 2A illustrates an example of the license calculation table 300 according to the present exemplary embodiment. Referring to FIG. 2A, the license calculation table 300 is a database that stores the number of licenses for each model of the MFP 102 and for each processing block, which is calculated based on the CO₂ emission amount and the power consumption per unit time for each MFP type (model) and for each processing block during execution of a job.

In calculating the number of licenses, the amount of CO₂ emitted in unit time of “1.0 (g/sec)” is set as equivalent to “1.0 license” in a CO₂ emission amount mode. Furthermore, the power consumption in unit time of “1.0 (w/sec)” is set as equivalent to “1.0 license” in a power consumption mode. However, alternatively, an amount different from the amount of CO₂ emitted in unit time of “1.0 (g/sec)” and the power consumption in unit time of “1.0 (w/sec)” can be used as the criterion for “1.0 license”.

As described above, the license quantity determination unit 203 generates the license calculation table 300. However, alternatively, the license calculation table 300 can be previously stored by the user (administrator) on the external memory of the SC 101.

An exemplary method for determining the license maximum value, which is executed by the license quantity determination unit 203, will be described in detail below. In determining the license maximum value, it is necessary that the license quantity determination unit 203 previously input upper limit value information via a screen 400 (FIG. 3) of the SC 101.

FIG. 3 illustrates an example of the screen 400 for determining the license maximum value according to the present exemplary embodiment. The screen 400 is displayed by the license quantity determination unit 203.

On the screen 400, a field 401 indicates a target CO₂ emission amount in unit time (g/sec). To paraphrase this, the field 401 indicates a target value of the total amount of CO₂ emitted by all the MFPs 102 within the system in the unit time.

A field 402 indicates the target power consumption in unit time (w/sec). In other words, the field 402 indicates a target value of the total power consumed by all the MFPs 102 within the system in the unit time. By using the value set to the CO₂ emission amount field 401 or the power consumption field 402 as an upper limit value, the license quantity determination unit 203 calculates and adjusts the number of licenses below or equal to the upper limit value.

A switch 403-1 can be operated to select the CO₂ emission amount mode for managing the upper limit value according to the CO₂ emission amount. A switch 403-2 can be operated to select a power consumption mode for managing the upper limit value according to the power consumption. The user can select either one of the switches 403-1 and 403-2.

In addition, the screen 400 includes an enter button 404. If the user has input an instruction via the enter button 404, the license quantity determination unit 203 determines the license maximum value according to the upper limit value corresponding to the management mode selected by operating the switch 403-1 or 403-2.

In other words, when the CO₂ emission amount mode is set by selecting the switch 403-1, the license maximum value is determined according to the value set to the CO₂ emission amount field 401. On the other hand, when the power consumption mode is set by selecting the switch 403-2, the license maximum value is determined according to the value set to the power consumption field 402.

In the present exemplary embodiment, the upper limit value of the CO₂ emission amount or the power consumption is simply determined as the license maximum value. More specifically, the license maximum value is determined by a method in which the CO₂ emission amount of “1 (g/sec)” is equivalent to “one license” in the CO₂ emission amount mode and in which the power consumption of “1 (w/sec)” is equivalent to “one license” in the power consumption mode.

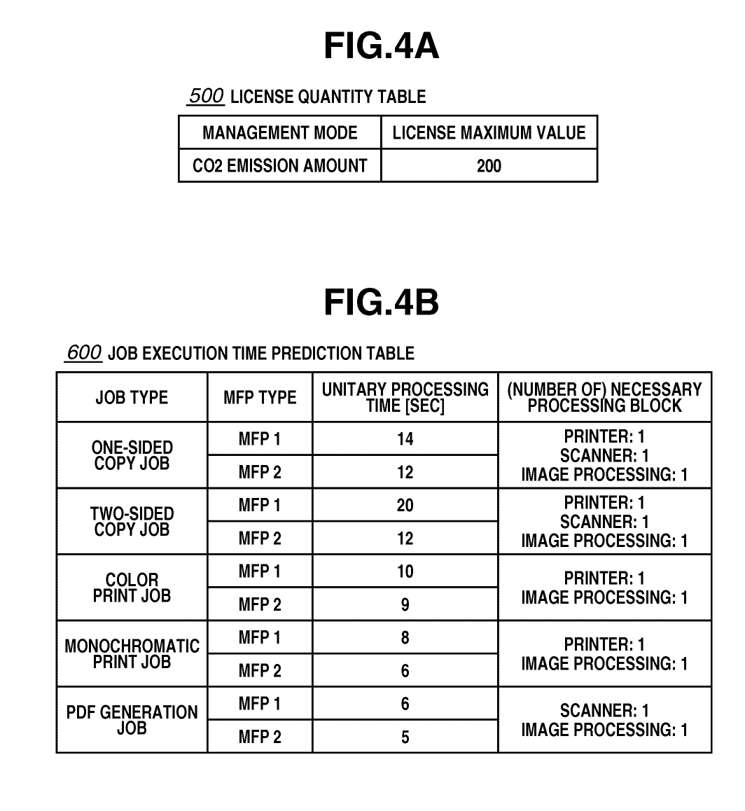

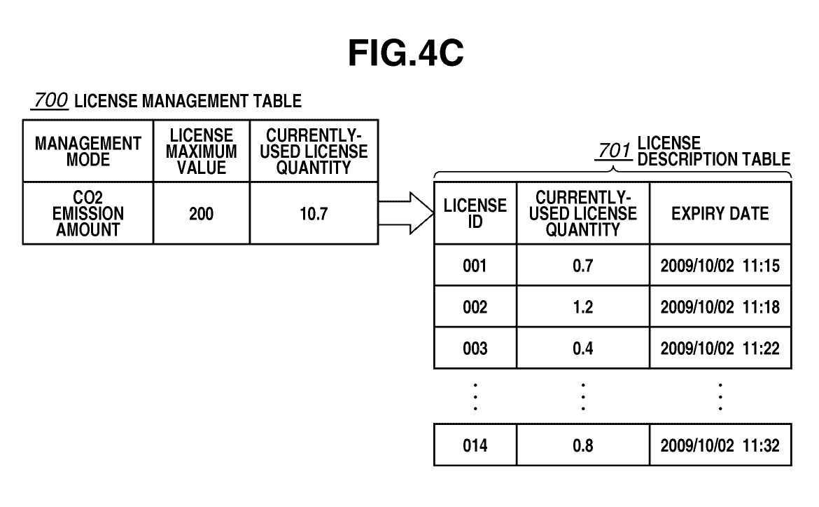

However, the present exemplary embodiment can determine a value calculated by dividing the upper limit value of the CO₂ emission amount or the power consumption amount by a consumption amount of one function (i.e., in the unit of a processing block), as the license maximum value. The determined license maximum value is stored in a license quantity table 500 illustrated in FIG. 4A, which is stored on the RAM of the SC 101.

As described above, the power consumption and the CO₂ emission amount in unit time of all the MFPs 102 that can execute different jobs at the same time are set as the number of licenses (the license maximum value) and the license calculation table 300 (FIG. 2A) is generated. With the above-described configuration, the present exemplary embodiment can control the power consumption and the CO₂ emission amount in unit time of all the MFPs 102 that can execute different jobs at the same time.

Alternatively, the following configuration can be employed. More specifically, the number of processing blocks that can execute different jobs at the same time is set as the license maximum value. Furthermore, a license calculation table in which the number of licenses of “1” is set to each MFP type (model) and to each processing block is generated. With the above-described configuration also, the present exemplary embodiment can control the number of processing blocks that can execute different jobs at the same time.

Further, alternatively, the following configuration can be employed. More specifically, the number of MFPs capable of executing different jobs at the same time is set as the license maximum value. Furthermore, the license calculation table merely stores the number of licenses for each MFP type but does not store the number of licenses for each processing block. In the license calculation table, the number of licenses for each MFP type can have a value “1”. With the above-described configuration, the present exemplary embodiment can control the number of MFPs capable of executing different jobs at the same time.

FIG. 4A illustrates an example of the license quantity table according to the present exemplary embodiment. Referring to FIG. 4A, the license quantity table 500 includes a management mode field and a license maximum value field, which stores and manages corresponding information. In other words, the management mode field stores information about the power consumption mode, in which the upper limit value is managed according to the power consumption, and the CO₂ emission amount mode, in which the upper limit value is managed according to the CO₂ emission amount, has been set.

If the license quantity table 500 has not been stored by the license quantity determination unit 203 or if it has been requested by the user (administrator), the screen 400 illustrated in FIG. 3 is displayed on a display device of the SC 101 under control of the license quantity determination unit 203.

The job execution time prediction unit 204 will be described in detail below. The job execution time prediction unit 204 acquires information about the MFP connected via the network I/F 201, such as a printing speed, a reading speed, and an image processing speed. Based on the acquired information, the job execution time prediction unit 204 generates and stores a job execution time prediction table 600 illustrated in FIG. 4B. More specifically, the job execution time prediction table 600 stores predicted job execution time for processing one page per MFP type (model) for each job type.

FIG. 4B illustrates an example of the job execution time prediction table 600 according to the present exemplary embodiment. Referring to FIG. 4B, in the job execution time prediction table 600, a job execution time prediction value (in unit job execution time (sec)) in the unit of one page (the unit of processing) for each job type and for each MFP type (model) is linked with each job type and each MFP type (model) and stored.

In the present exemplary embodiment, the job type includes “one-sided copy job”, “two-sided copy job”, “color print job”, “monochromatic print job”, and “portable document format (PDF) generation job”. However, a job different from the above-described jobs can be input. In addition, information about a processing block necessary for each job type is linked with each job type and stored in the job execution time prediction table 600.

As described above, in the present exemplary embodiment, the job execution time prediction unit 204 generates the job execution time prediction table 600. However, alternatively, the user (administrator) can previously store the job execution time prediction table 600 on the external memory of the SC 101.

The license request processing unit 206 will be described in detail below. The license request processing unit 206 acquires the license quantity table 500 (FIG. 4A) and the job execution time prediction table 600 (FIG. 4B). In addition, the license request processing unit 206 generates a license management table 700 (FIG. 4C) based on the license quantity table 500 (FIG. 4A). The generated license management table 700 is stored on the RAM of the SC 101.

Referring to FIG. 4C, the license management table 700 stores and manages the management mode, the license quantity maximum value, the number of licenses in use, and a license description table 701. The license description table 701 stores the number of licenses in use and the expiry date for each license identification (ID). In other words, the license request processing unit 206 issues a license having a valid term to the MFP 102.

The license ID is a value uniquely set to each license that is given to the MFP. The license IDs are generated in order of issued licenses. At the time of the generation of the license management table 700, the number of licenses in use is “0”. In this state, the license description table 701 stores no data. In later processing, the license request processing unit 206 manages the license by using the license management table 700.

The license request processing unit 206 manages the valid term of each license. The license request processing unit 206 deletes information about a license whose valid term has expired (hereinafter may be simply referred to as an “expired license”) from the license description table 701.

In addition, the license request processing unit 206 subtracts the number of used licenses included in the deleted license information from the number of licenses in use stored in the license management table 700. By executing the above-described processing, the present exemplary embodiment can provide the expired license to another request.

The license can be requested by the MFP 102 transmitting a license request return packet 800 (FIG. 2B) to the SC 101. The license request return packet 800, which has been transmitted from the MFP 102 on the NW 104, is transmitted to the license request processing unit 206 via the network I/F unit 201.

The license request processing unit 206 enqueues the received license request return packet 800 in a processing queue of the license request processing unit 206 first. Then the license request processing unit 206 processes the license request return packet 800 in order of reception thereof.

The license request return packet 800 has the following structure (FIG. 2B). FIG. 2B illustrates an exemplary structure of the license request return packet 800 according to the present exemplary embodiment.

Referring to FIG. 2B, a request host field 801 stores a request host. More specifically, the request host field 801 indicates a name of the MFP 102 that has input a request for issuing or returning the license. The request host field 801 can usually store an Internet protocol (IP) address or a host name. A reply to the license request is executed to a host having the host name stored in the request host field 801.

A host type field 802 stores a host type. To paraphrase this, the host type field 802 stores the type (model) of the MFP 102 that has input the license request. A field 803 stores the type of the job to be executed. In other words, the field 803 stores the type of the job to be executed by the MFP 102. The execution target job type field 803 stores information, such as “one-sided copy”, “two-sided copy”, “color printing”, or “monochromatic printing”.

A processing target page quantity field 804 describes the number of pages to be processed. If the precise total number of pages to be processed has been known before executing a job as in a print job, the processing target page quantity field 804 stores the total number of pages to be processed. On the other hand, if the precise total number of pages to be processed is not known before executing a job as in a scan job, the processing target page quantity field 804 stores the maximum number of pages that can be read by the MFP 102 by one operation.

Via fields 805 through 808, the user can designate the processing block to be used in each job. A parameter value “1” is stored in the field corresponding to the processing block used in the job. More specifically, in the example illustrated in FIG. 2B, the parameter value “1” is stored in an image processing block field 805 and a print block field 806 while the parameter value “0” is stored in a scan block field 806 and a post-processing block 808. In other words, in this case, the information stored in the license request return packet 800 indicates that the image processing block and the print block are used in processing the corresponding job.

A field 809 is a field for determining the type as to the license request and license return. If the parameter value “1” has been set to the field 809, it is indicated that a license request has been input. On the other hand, if the parameter value “0” has been set to the field 809, it is indicated that a license return request has been input.

A field 810 stores a license ID uniquely provided to the license. At the time of license request, it is not yet finally determined which license is to be given. Accordingly, in this timing, the parameter value “0” is set to the license ID field 810. On the other hand, when the license is returned, the license ID that is transmitted to the MFP 102 when the license is requested is set to the license ID field 810.

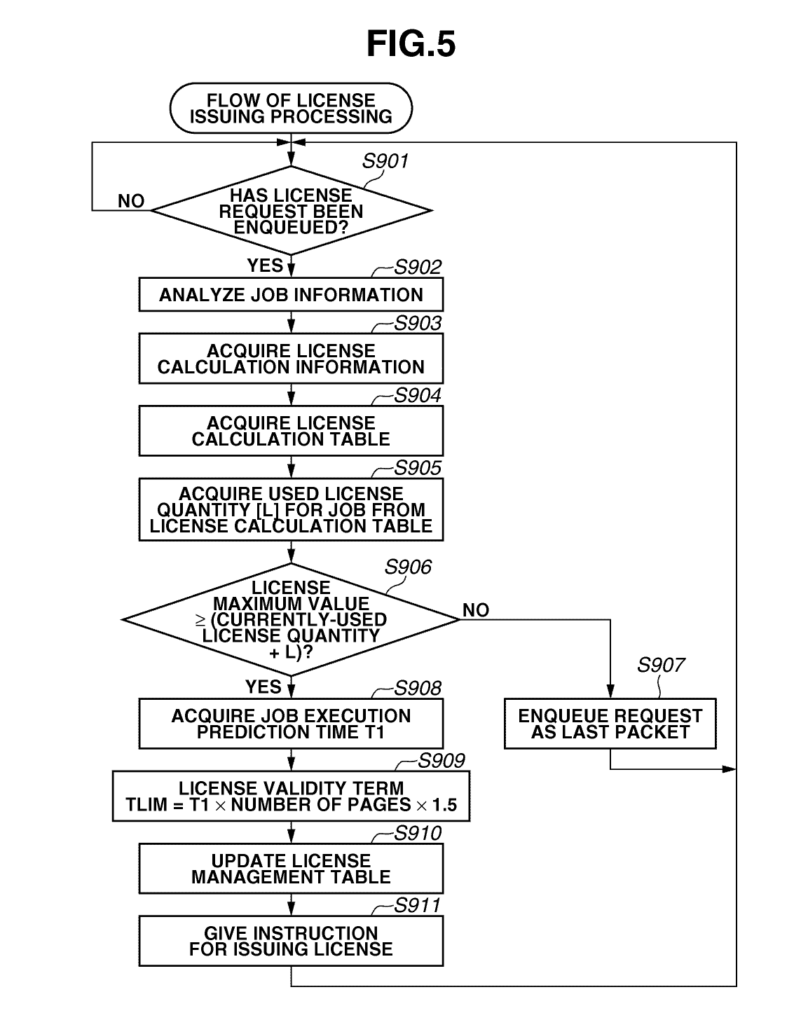

Now, processing for issuing a license according to the present exemplary embodiment will be described in detail below with reference to the flow chart of FIG. 5.

When a packet is transmitted from the MFP, the packet is enqueued (temporarily stored) in a processing queue of the license request processing unit 206 via the network I/F unit 201.

FIG. 5 is a flow chart illustrating an example of the license issuing processing according to the present exemplary embodiment. The processing illustrated in FIG. 5 is executed by the license request processing unit 206 (the CPU of the SC 101).

Referring to FIG. 5, in step S901, the license request processing unit 206 extracts the license request return packet 800 (FIG. 2B), from first packet stored in the processing queue. In addition, the license request processing unit 206 refers to the license request/return identification field 809 of the packet and searches for a packet that includes a license request (i.e., a packet whose field 809 has a parameter value “1”)).

If it is determined that no packet that instructs license request processing is included in the processing queue (No in step S901), then the processing returns to step S901 and the processing in step S901 is repeated.

On the other hand, if it is determined that any packet that instructs license request processing has been extracted (Yes in step S901), then the license request processing unit 206 determines that a packet for a license request exists in the processing queue. Then the processing advances to step S902.

In step S902, the license request processing unit 206 acquires the license request packet from the queue and analyzes the acquired packet. By the analysis, the license request processing unit 206 identifies the request host, the host type, the type of the job to be executed, the number of pages to be processed, and the necessary processing block.

In step S903, the license request processing unit 206 acquires information from the license management table 700 (FIG. 4C). In step S904, the license request processing unit 206 acquires the license calculation table 300 (FIG. 2A) from the license quantity determination unit 203. In step S905, the license request processing unit 206 acquires the number of licenses used in the job from the license calculation table 300 (FIG. 2A) according to the acquired information.

In the present exemplary embodiment, it is supposed that the “CO₂ emission amount” mode has been set to the management mode field of the license management table 700 (FIG. 4C).

In this case, the number of licenses used in the job can be calculated in the following manner. More specifically, a available license quantity L is calculated based on information stored in the license calculation table 300 (FIG. 2A), the host type included in the license request return packet, and the processing block to be used.

For example, the available license quantity L can be calculated by adding together the number of licenses for the MFP stored in the host type field 802 and the number of licenses (counted in the CO₂ emission amount mode) for processing blocks (805 through 808) having the parameter value “1” in the license request return packet 800, which can be acquired from the license calculation table 300.

More specifically, the packet illustrated in FIG. 2B includes the parameter value “MFP 1” for the host type and “image processing” and “print” for the processing block to be used. Furthermore, in the license calculation table 300 illustrated in FIG. 2A, the license per unit of image processing (CO₂) for the MFP 1 has a value “0.1” and the license per unit of printing (CO₂) for the MFP 1 has a value “1.2”. Accordingly, the available license quantity L becomes “1.3”, which is calculated by adding the license per unit of image processing (CO₂) for the MFP 1 (“0.1”) to the license per unit of printing (CO₂) for the MFP 1 (“1.2”).

In step S906, the license request processing unit 206 determines whether the license maximum value is equal to or greater than the sum of the number of licenses in use and the available license quantity L. If it is determined that the license maximum value is neither equal to nor greater than the sum of the number of licenses in use and the available license quantity L (No in step S906), then the license request processing unit 206 determines that a license cannot to be issued. Then the processing advances to step S907.

In step S907, the license request processing unit 206 stores the license request return packet for the license request in the queue again and suspends the processing of the license request. Then the processing returns to step S901. On the other hand, if it is determined that the license maximum value is equal to or greater than the sum of the number of licenses in use and the available license quantity L (Yes in step S906), then the license request processing unit 206 determines that a license can be issued. Then the processing advances to step S908.

In step S908, the license request processing unit 206 refers to the job execution time prediction table 600 (FIG. 4B), which is stored in the job execution time prediction unit 204. Furthermore, the license request processing unit 206 acquires unit processing time in which the type of job to be executed and the host type acquired from the packet become the same as the job type and the type of MFP stored in the job execution time prediction table 600. The unit processing time is set as job execution prediction time T1 for processing one page.

More specifically, in the packet illustrated in FIG. 2B, the type of job to be executed is “color printing” and the host type is “MFP 1”. Accordingly, the job execution prediction time T1 becomes “10 (sec)”.

In step S909, the license request processing unit 206 calculates a license valid term Tlim. The license valid term Tlim can be calculated by multiplying the job execution prediction time T1 by the number of pages to be processed and the adjustment value (“1.5” in the present exemplary embodiment). To paraphrase this, the license valid term Tlim can be calculated by the following expression:

$$License valid term T lim = job execution prediction time T 1 \times number of pages to be processed \times 1.5 .$$

More specifically, in the packet illustrated in FIG. 2B, the number of pages to be processed is “20”. Accordingly, the license valid term Tlim becomes 10×20×1.5=300 (sec).

In step S910, the license request processing unit 206 adds the license valid term Tlim to the present time and calculates the expiry date of the license. In addition, the license request processing unit 206 registers the calculated expiry date and the available license quantity L in the license description table 701 of the license management table 700 (FIG. 4C). For the license ID, a license ID unique within the license description table 701 is registered. In addition, the license request processing unit 206 updates the in-use license quantity stored in the license management table 700 (FIG. 4C) with the sum of the number of currently used licenses and the available license quantity L.

In step S911, the license request processing unit 206 instructs the license issuing unit 202 to issue a license as a reply to the license request. Then, the processing returns to step S901. The instruction for issuing a license includes the license ID and the expiry date registered in the license description table 701 and the information about the request host and the processing block included in the license request return packet.

When the license issuing instruction is received, the license issuing unit 202 generates a license packet 1000. The generated license packet 1000 is transmitted to the MFP that has issued the license request (the request host included in the license issuing instruction).

Referring to FIG. 2C, an ID that has been stored in the license description table 701 (FIG. 4C) as a result of the license issuing processing illustrated in FIG. 5 is set to a license ID 1001. Similarly, an expiry date that has been stored in the license description table 701 (FIG. 4C) as a result of the license issuing processing illustrated in FIG. 5 is set to a license expiry date 1002. Each of fields 1003 through 1006 stores detailed information about the license to be issued.

Accordingly, the license can be used for the processing block whose field 1003 through 1006 has a parameter value “1” (i.e., the corresponding processing block can be used) within the valid term.

For the fields 1003 through 1006, a parameter value “1” is set to the field corresponding to any of fields 805 through 808 included in the license request packet to which a parameter value “1” has been set. For the other fields, a parameter value “0” is set.

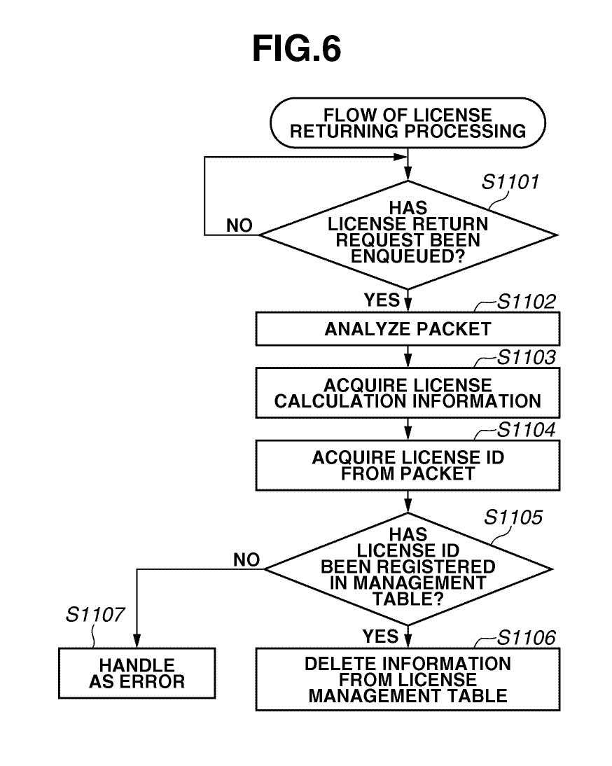

Now, an example of license returning processing according to the present exemplary embodiment will be described in detail below with reference to the flow chart of FIG. 6.

In the flow chart of FIG. 6, processing in step S1101 is executed by the license request processing unit 206. On the other hand, processing in steps S1102 through S1107 is executed by the license returning unit 205 (the CPU of the SC 101).

Referring to FIG. 6, in step S1101, the license request processing unit 206 loads the packet 800 (FIG. 2B) from the processing queue, which has been stored as the first packet. In addition, the license request processing unit 206 searches for a packet that includes a license returning instruction in the license request/return identification field 809 thereof (in other words, the license request processing unit 206 searches for a packet whose field 809 has a value “0”).

If any packet that instructs license returning processing has been extracted (Yes in step S1101), then the license request processing unit 206 determines that a packet for returning the license exists in the processing queue. Furthermore, the license request processing unit 206 transmits the license returning packet to the license returning unit 205.

In step S1102, after receiving the license returning packet, the license returning unit 205 analyzes the license request return packet 800 (FIG. 2B) to identify the request host, the host type, the type of job to be executed, the number of pages to be processed, and the necessary processing block.

In step S1103, the license returning unit 205 acquires the information from the license management table 700 (FIG. 4C), such as the management mode, the license maximum value, the number of licenses in use, and the license description table 701). In step S1104, the license returning unit 205 acquires the license ID of the license to be returned (the value of the license ID field 810 illustrated in FIG. 2B) from the license returning packet 800.

In step S1105, the license returning unit 205 determines whether the license ID acquired in step S1104 has been registered in the license description table 701 of the license management table 700 (FIG. 4C) as an already-issued license. If it is determined that the license ID acquired in step S1104 has been registered in the license description table 701 of the license management table 700 (FIG. 4C) (Yes in step S1105), then the processing advances to step S1106.

In step S1106, the license returning unit 205 deletes information (the license ID, the available license quantity, and the expiry date) corresponding to the license ID acquired in step S1104 from the license description table 701 of the license management table 700 (FIG. 4C). In addition, the license returning unit 205 updates the number of licenses in use in the license management table 700 (FIG. 4C) with the value calculated by subtracting the deleted number of used licenses from the number of licenses in use in the license management table 700 (FIG. 4C).

By executing the above-described processing, the number of returned licenses can be provided according to other requests. Then the processing returns to step S1101.

On the other hand, if it is determined that the license ID acquired in step S1104 has not been registered in the license description table 701 of the license management table 700 (FIG. 4C) (No in step S1105), then the processing advances to step S1107. In step S1107, the license returning unit 205 notifies an error to the user. Then the processing returns to step S1101.

If a license request has been input by each MFP 102 by executing the above-described operation, the SC 101, which is the management apparatus, can manage the license by executing appropriate processing if the returning of a license has been executed.

Now, an exemplary configuration of the MFP 102 will be described in detail below.

Referring to FIG. 7A, a CPU 1203 is connected to a system bus 1201 and an image bus 1209. A read-only memory (ROM) 1202 stores a system boot program. System software that can implement each functional unit of the present invention is recorded on the ROM 1202 or a storage memory 1205 (computer-readable storage medium) as computer-executable instructions. The system software is implemented by the CPU 1203.

A RAM 1204 is a system work memory area used by the CPU 1203 to execute the software. The RAM 1204 is also used as an image memory for storing image data read by the reading unit 1212 and for temporarily storing the read image data in a format with which the image data can be printed by the printer unit 1213. The storage memory 1205 stores image data and the system software.

The input and output (IO) control unit B 1207 is an interface with an operation unit 1215. The IO control unit B 1207 outputs image data to be displayed on the operation unit 1215 to the operation unit 1215. The IO control unit B 1207 transmits information input by the user of the system via the operation unit 1215 to the CPU 1203. A local area network (LAN) interface (I/F) unit 1206 is an interface with a LAN. Information can be input and output to and from each apparatus connected to the LAN.

In the present exemplary embodiment, the communication with and a license request to, and the return of the license to the SC 101 are executed via the LAN I/F unit 1206. In addition, the LAN I/F unit 1206 is also used as a data input interface for receiving a print job from the client PC 103, which exists on the NR. The above-described devices are mutually connected via the system bus 1201.

An IO control unit A 1208 connects the system bus 1201 to the image bus 1209. The image bus 1209 is used to transfer image data at a high speed. The IO control unit A 1208 is a bus bridge that converts the structure of data on the system bus 1201.

The image bus 1209 is constituted by a peripheral component interconnect (PCI) bus or Institute of Electrical and Electronic Engineers (IEEE) 1394. To the image bus 1209, the reading unit 1212, which is an image IO device, the printer unit 1213, the post-processing unit 1214, and the image processing unit 1210 are connected. The image bus 1209 executes synchronous/asynchronous conversion of the image data.

The image processing unit 1210 executes various image processing, such as resolution conversion, compression and decompression, and binary-multivalued conversion, on input image data and image data to be output.

The reading unit 1212 reads an image of a medium such as paper. After executing necessary image processing by the image processing unit 1210 on the read image data, the image is stored on the storage memory 1205 via the image bus 1209. The printer unit 1213 reads the image from the storage memory 1205 via the image bus 1209, forms the image on a recording medium such as paper and outputs the image.

The post-processing unit 1214 executes post-processing, such as stapling, folding, and cutting, on the medium (paper) having the recorded image thereon and having been output by the printer unit. The image processing unit 1210, the reading unit 1212, the printer unit 1213, and the post-processing unit 1214 correspond to the above-described processing blocks.

The operation unit 1215 is constituted by an LCD touch panel. Furthermore, the operation unit 1215 interprets a video graphics array (VGA) signal output from the IO control unit B 1207 and displays the interpreted signal. In addition, the operation unit 1215 includes a switch for instructing the restoration from the low power state 1301.

The power control unit 1211 executes control for supplying power to the image processing unit 1210, the reading unit 1212, the printer unit 1213, and the post-processing unit the 1214. More specifically, the power control unit 1211 can supply power to the image processing unit 1210, the reading unit 1212, the printer unit 1213, and the post-processing unit 1214 independently from one another.

Even when power is not supplied to the CPU 1203, the power control unit 1211 can start processing by supplying power to the CPU 1203, the ROM 1202, and the RAM 1204, which are necessary for the processing, according to an instruction input by the user by pressing the restoration instruction switch on the operation unit 1215 or when it is detected that a packet from the network has been received.

In the present exemplary embodiment, the power control unit 1211 has a plurality of states (modes), which can be selected according to the status of progress of processing of an input job. The power supply is controlled according to information stored in a table 1300 illustrated in FIG. 713.

FIG. 7B illustrates the shift of power control states of the MFP and a current feeding point.

Referring to FIG. 7B, in a table 1300, a circle (“∘”) indicates a state in which power is supplied to each processing unit. A cross (“x”) indicates a state in which power is not supplied to each processing unit. Furthermore, a bar (“-”) indicates a state in which the power supply state and the power non-supply state is switched according to the license.

When the user does not execute any operation or when no job has been executed, the low power state 1301 is maintained. In the low power state 1301, no power is supplied to any of the image processing unit 1210, the printer unit 1213, the reading unit 1212, the post-processing unit 1214, and the operation unit 1215 of the MFP 102 as illustrated in the table 1300.

However, even in the low power state 1301, power is supplied to the switch for instructing the restoration from the low power state 1301, which is provided on the operation unit 1215, and to a portion for processing a trigger signal, which is input when a packet has been received from the NR. When a trigger signal is input to the MFP 102, the state of the MFP 102 shifts to the job receiving state 1302, in which the user can input an instruction or values via the operation unit 1215.

In the job receiving state 1302, power cannot be supplied to the image processing unit 1210, the printer unit 1213, the reading unit 1212, and the post-processing unit 1214 of the MFP 102 while power can be supplied to the operation unit 1215. In the job receiving state 1302, the MFP 102 can receive an instruction for executing a job according to an input executed via the user I/F (the operation unit 1215). Furthermore, in the job receiving state 1302, the MFP 102 can input a license request to the SC 101 via the network I/F (the LAN I/F unit 1206).

If an operation for executing a job has been executed via the operation unit 1215 or if a print instruction has been received from the client PC 103 on the NR, the MFP 102 inputs a license request to the SC 101 according to the job type. The MFP 102 maintains the job receiving state 1302 until the requested license is given by the SC 101. After the license is given by the SC 101, the MFP 102 shifts to the operating state 1303.

When the MFP 102 is in the operating state 1303, whether to supply power to the image processing unit 1210, the printer unit 1213, the reading unit 1212, and the post-processing unit 1214 varies according to the license while power is supplied to the operation unit 1215. Furthermore, in the operating state 1303, the MFP 102 executes the job by supplying power to each processing unit according to the license.

When the job is completely executed, the MFP 102 returns the license to the SC 101. Then the MFP 102 immediately shifts to the low power state 1301 or at first shifts to the job receiving state 1302 until a predetermined time period elapses and then shifts to the low power state 1301 after the predetermined time period has elapsed.

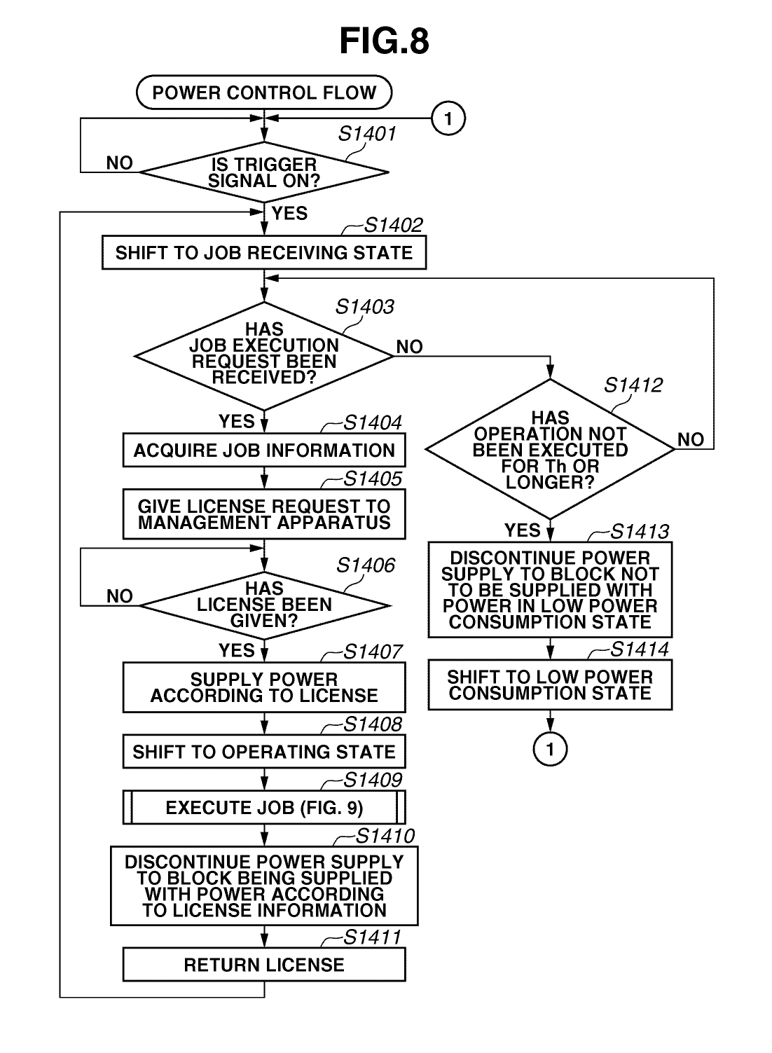

FIG. 8 is a flowchart illustrating an example of power control by the MFP 102 according to the present exemplary embodiment. Processing in the flow chart of FIG. 8 is implemented by the CPU 1203 loading and executing the computer-executable program from the ROM 1202.

Referring to FIG. 8, in step S1401, in the low power state 1301, the CPU 1203 maintains the low power state 1301 until a trigger signal is input when a return instruction is input via the operation unit 1215 or when a packet is received from the NR. More specifically, in step S1401, the CPU 1203 determines whether a trigger signal has been input. If it is determined that a trigger signal has been input (Yes in step S1401), then the processing advances to step S1402. In step S1402, the MFP 102 shifts to the job receiving state 1302.

In step S1403, i.e., after the MFP 102 has shifted to the job receiving state 1302, the CPU 1203 determines whether the user has input any job via the client PC 103 on the NW or via the operation unit 1215. If it is determined that a job has been input (Yes in step S1403), then the processing advances to step S1404.

In step S1404, the CPU 1203 acquires detailed information from the input job execution instruction. In step S1405, the CPU 1203 generates the license request return packet 800 (FIG. 2B) based on the information about the type of the instructed job and the instructed processing block to be used. More specifically, the CPU 1203 sets a parameter value “1” to the license request/return identification field 809 of the license request return packet and transmits the generated packet to the SC 101, which is the management apparatus.

In step S1406, the CPU 1203 maintains the job receiving state 1302 until a license (the license packet 1000 (FIG. 2C)) is given (i.e., the CPU 1203 determines whether a license has been given). If it is determined that a license has been given (Yes in step S1406), then the processing advances to step S1407. In step S1407, the CPU 1203 supplies power to the processing block (the processing block that has been permitted to be used under the license) according to the license information (the license packet 1000 (FIG. 2C)). In step S1408, the MFP 102 shifts to the operating state 1303.

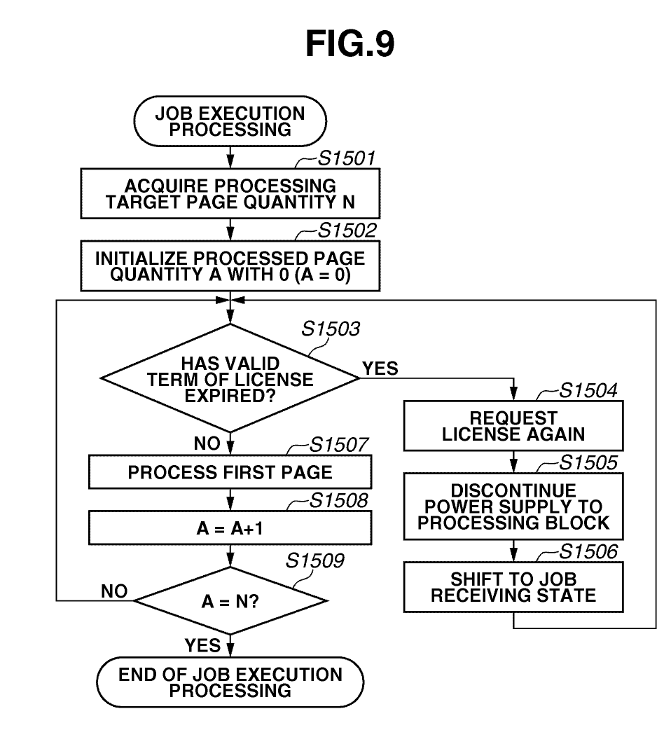

In step S1409, the CPU 1203 executes the requested job (to be described in detail below with reference to FIG. 9). After completing the execution of the job, the processing advances to step S1410. In step S1410, the CPU 1203 discontinues the supply of power to each processing unit.

In step S1411, the CPU 1203 generates the license request return packet 800 (FIG. 2B), which is used for returning the license to the SC 101. More specifically, in step S1411, the CPU 1203 sets a parameter value “0” to the license request/return identification field 809 of the license request return packet. In addition, the CPU 1203 sets the license ID of the license to be returned to the license ID field 810 of the license request return packet. Furthermore, the CPU 1203 transmits the generated packet to the SC 101, which is the management apparatus. Then the processing returns to step S1402. In step S1402, the MFP 102 shifts to the job receiving state 1302.

On the other hand, if it is determined that that the user has not input a job execution request (No in step S1403), then the processing advances to step S1412. In step S1412, the CPU 1203 determines whether time Th has elapsed since the state of the MFP 102 has shifted to the job receiving state 1302. The time Th, which is threshold time for shifting to the low power state 1301, can be set differently for each MFP. Furthermore, the time Th is a value stored on the ROM 1202 or a value loaded on the RAM 1204 from the ROM 1202 as configuration data for each MFP.

If it is determined that the time Th has not elapsed yet after shifting to the job receiving state 1302 (No in step S1412), then the processing returns to step S1403. On the other hand, if it is determined that the time Th has already elapsed after shifting to the job receiving state 1302 (Yes in step S1412), then the processing advances to step S1413. In step S1413, the CPU 1203 shifts the state of the MFP 102 to the low power state 1301 and discontinues the supply of power to unnecessary unit.

In step S1414, the CPU 1203 shifts the state of the MFP 102 to the low power state 1301. Then the processing returns to step S1401. In step S1401, the CPU 1203 waits until a trigger signal is input.

By executing the power control according to the flow chart of FIG. 8, the MFP 102 can control the power supply according to the license.

FIG. 9 is a flow chart illustrating an exemplary flow of the job execution processing in step S1409 of the flow chart of FIG. 8. Processing in the flow chart of FIG. 9 is implemented by the CPU 1203 loading and executing the computer-executable program from the ROM 1202.

Referring to FIG. 9, in step S1501, the CPU 1203 acquires a processing target page total quantity N. In step S1502, the CPU 1203 initializes a processed page quantity A with a value “0”.

In step S1503, the CPU 1203 compares the expiry date included in the license information (the license packet 1000), which has been acquired from the SC 101 as the license, with the present time to determine whether the valid term of the license has expired.

If it is determined that the valid term of the license has expired (Yes in step S1503), then the processing advances to step S1504. In step S1504, the CPU 1203 inputs a license request again. In other words, in step S1504, the CPU 1203 generates the license request return packet 800 (FIG. 2B), which is similar to the packet generated in step S1405 (FIG. 8) and transmits the generated license request return packet 800 (FIG. 2B) to the SC 101.

After inputting the license request again, the processing advances to step S1505. In step S1505, the CPU 1203 discontinues the supply of power to each processing block, which has been powered on when the job is processed. In step S1506, the CPU 1203 shifts the state of the MFP 102 to the job receiving state 1302. Then the processing returns to step S1503.

On the other hand, if it is determined that the valid term of the license has not expired yet (No in step S1503), then the processing advances to step S1507. In step S1507, the CPU 1203 processes one page. In step S1508, the CPU 1203 increments an already-processed page quantity A by 1.

In step S1509, the CPU 1203 compares the processing target page quantity N with the already-processed page quantity A. More specifically, the CPU 1203 determines whether all the pages have been completely processed (whether A=N). If it is determined that not all the pages have been completely processed yet (A≠N) (No in step S1509), then the processing returns to step S1503. In step S1503, the CPU 1203 starts processing of a next page.

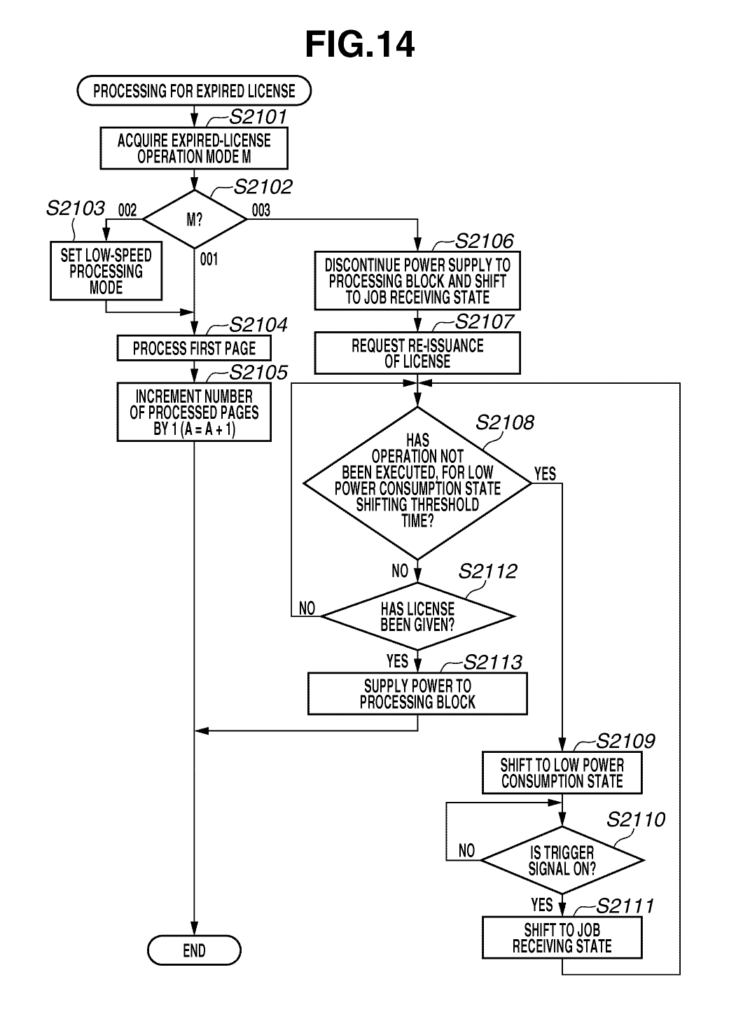

On the other hand, if it is determined that all the pages have been completely processed (A=N) (Yes in step S1509), then the CPU 1203 returns to the main processing, which is the processing described above with reference to the flow chart of FIG. 14.

By executing the above-described processing, the MFP 102 is capable of controlling the power supply according to the license information given by the SC 101, which is generated based on the upper limit value of the license determined according to the CO₂ emission total amount or the total power consumption in unit time. With the above-described configuration, the present exemplary embodiment can suppress and reduce the total CO₂ emission total amount and the total power consumption of all the MFPs within the system to be equal to or below the setting value without reducing the number of MFPs connected to the entire system.

In the first exemplary embodiment described above, whether to shift from the job receiving state 1302 to the low power state 1301 is independently determined and controlled by each MFP. In other words, in the first exemplary embodiment, the time for shifting to the low power state 1301 can be different for different MFP models.

Because power is supplied to the operation unit 1215 in the low power state 1301 and the job receiving state 1302 in the similar manner as in the operating state 1303, power may be wastefully consumed during standby. In addition, if the license has expired, the license may be unconditionally requested again and again. In this case, the MFP may wait for a license for a long time. Accordingly, in this case, the user may be required to wait, for a long time. A second exemplary embodiment of the present invention is a method for solving the above-described problem. The present exemplary embodiment has the same basic configuration as that of the first exemplary embodiment. Accordingly, the detailed description thereof will not be repeated here.

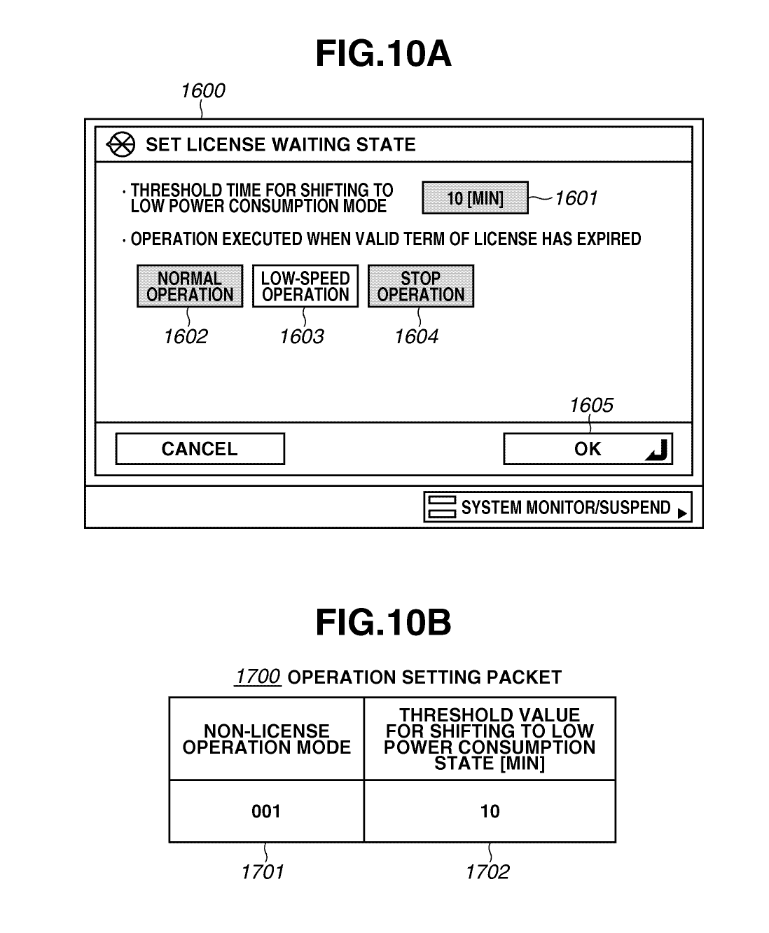

FIG. 10A illustrates an example of a screen for executing a setting for an expired license according to the present exemplary embodiment. Referring to FIG. 10, the user can set threshold time for shifting from the job receiving state 1302 to the low power state 1301 for each MFP 102 and an operation of the MFP 102 executed if the valid term of the license has expired. The screen 1600 is displayed by the license request processing unit 206.

The threshold time for setting the time for shifting to the low power state 1301 can be set to the field 1601. The license request processing unit 206 sets the time for shifting to the low power state 1301 to each MFP 102 according to the value input to the field 1601. Keys (non-license operation mode setting keys) 1602 through 1604 can be operated by the user to set a non-license operation mode for executing an operation for an expired license.

When the key 1602 is pressed by the user, a normal operation mode is set to each MFP 102. In the normal operation mode, a normal operation is continued for a currently processed job even if the license has already expired. When the key 1603 is pressed by the user, a low-speed operation mode is set to each MFP 102. In the low-speed operation mode, a low-speed operation is performed, in which the job is processed at a decreased processing speed if the license has already expired. When the key 1604 is pressed by the user, an operation inhibition mode is set to each MFP 102. In the operation inhibition mode, the execution of the job is discontinued if the license has already expired. The user can select only either one of the keys 1602 through 1604.

When the user presses an OK key 1605 after setting the values via the field 1601 and the keys 1602 through 1604, the license request processing unit 206 generates an operation setting packet 1700 (FIG. 10B) and transmits the generated operation setting packet 1700 (FIG. 10B) to each MFP 102.

FIG. 10B illustrates an example of an operation setting packet according to the present exemplary embodiment. Referring to FIG. 10B, the operation setting packet 1700 includes an expired-license operation mode field 1701 and a low power consumption state-shifting threshold value field 1702.

The non-license operation mode field 1701 is a field for setting the mode of the operation executed when the license has expired. Parameter values (IDs) “001”, “002”, and “003” correspond to the normal operation mode, the low-speed operation mode, and the operation inhibition mode, respectively. In this manner, the operation mode is set according to the ID assigned to each operation mode.

The low power consumption state-shifting threshold value field 1702 is a field for setting the threshold time for shifting from the job receiving state 1302 to the low power state 1301. To paraphrase this, each MFP 102 shifts to the low power state 1301 after the threshold time set to the low-power-consumption-state-shifting threshold value field 1702 has elapsed when the job is completely executed.

After receiving the operation setting packet 1700, the CPU 1203 of each MFP 102 stores the value set to the expired-license operation mode field 1701 on the RAM 1204 as a non-license operation mode M. In addition, the CPU 1203 of each MFP 102 stores the value set to the low power consumption state-shifting threshold value field 1702 on the RAM 1204 as low power state-shifting threshold time Th.

The low power state-shifting threshold time Th, which is stored on the RAM, is the threshold value referred to in step S1412 of the processing in the flow chart of FIG. 8. In other words, the MFP 102 can shift to the low power state 1301 only after the time set to the operation setting packet 1700 (FIG. 10B), which is transmitted from the SC 101, has elapsed.

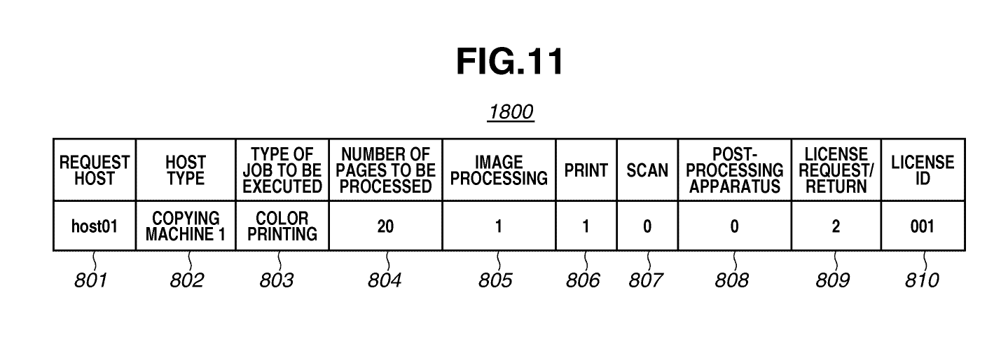

Now, exemplary processing for extending the license will be described in detail below. The license extension processing starts when the license request return packet 800 (FIG. 2B) having a value “2”, which corresponds to extension of the license and which has been set to the license request/return identification field 809 of the license request return packet 800 (FIG. 2B), is transmitted from the MFP 102 to the SC 101. It is supposed that the same value as the value of the license to be extended is set to the fields of the license request return packet 800 (FIG. 2B) except the license request/return identification field 809. If the MFP 102 that has received the license packet 1000 requests the extension of the license, the MFP 102 transmits a license request packet 1800 (FIG. 11) to the SC 101.

FIG. 11 illustrates an example of a license request return packet, which is transmitted from the MFP 102 to the SC 101 when the extension of a license is requested. Referring to FIG. 11, as to a license request return packet transmitted in extending a license, values in the license ID field 810 and the license request/return identification field 809 are different from those set in requesting the license.

In other words, in the example illustrated in FIG. 11, a license ID of the license to be extended is set to the license ID field 810. Furthermore, a parameter value “2”, which corresponds to “extend the corresponding license”, is set to the license request/return identification field 809.

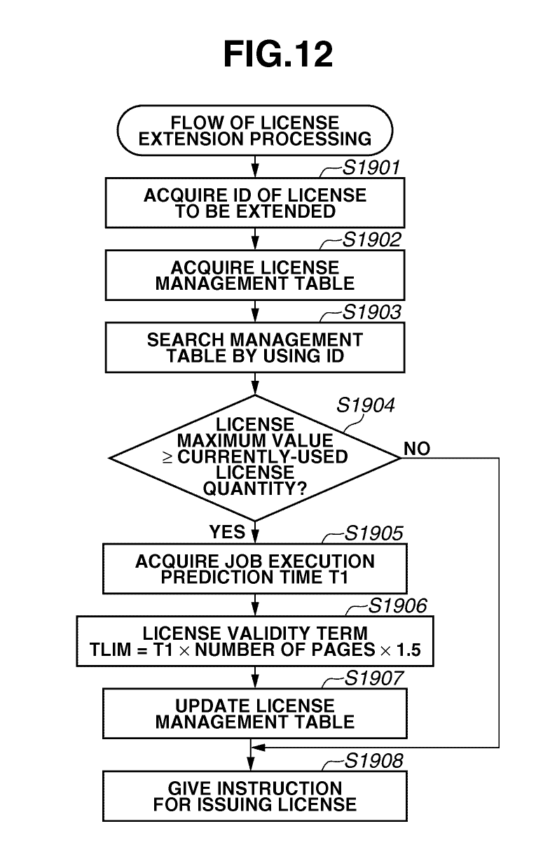

If the license request return packet 800, which includes the parameter value “2” in the license request/return identification field 809, is received by the SC 101 and acquired from the processing queue, then the license request processing unit 206 executes extension processing illustrated in FIG. 12.

FIG. 12 is a flow chart illustrating an example of license extension request processing according to the present exemplary embodiment. The license extension request processing is executed by the license request processing unit 206 (the CPU of the SC 101).

Referring to FIG. 12, in step S1901, the license request processing unit 206 acquires the license ID of the license to be extended from the license ID field 810 of the acquired license extension request packet. In step S1902, the license request processing unit 206 acquires the information from the license management table 700 (FIG. 4C).

In step S1903, the license request processing unit 206 searches the license description table 701 of the license management table 700 (FIG. 4C) by using a key of the license ID acquired in step S1901. In addition, the license request processing unit 206 acquires detailed license information corresponding to the license ID.

In step S1904, the license request processing unit 206 acquires the license maximum value and the number of licenses in use from the license management table 700 (FIG. 4C). Furthermore, in step S1904, the license request processing unit 206 determines whether the license maximum value is equal to or greater than the number of licenses in use.

If it is determined that the license maximum value is neither equal to nor greater than the number of licenses in use (NO in step S1904), then the processing directly advances to step S1904. On the other hand, if it is determined that the license maximum value is equal to or greater than the number of licenses in use (Yes in step S1904), then the processing advances to step S1905.

Even if the license maximum value is equal to or greater than the number of licenses in use, if any MFP exists that currently waits for an available license to be given (if any MFP has issued a license issuing request), the processing can directly advance to step S1908.

In step S1905, the license request processing unit 206 refers to the job execution time prediction table 600 (FIG. 4B), which is stored by that the job execution time prediction unit 204. Furthermore, the license request processing unit 206 acquires unit processing time, at which the type of job to be executed and the host type acquired from the packet becomes the same as the job type and the MFP type stored in the job execution time prediction table 600, as job execution prediction time T1 per one page.

In step S1906, the license request processing unit 206 calculates the license valid term Tlim. The license valid term Tlim can be calculated by multiplying the job execution prediction time T1 by the number of pages to be processed and the adjustment value (“1.5” in the present exemplary embodiment). To paraphrase this, the license valid term Tlim can be calculated by the following expression:

$$License valid term T lim = job execution prediction time T 1 \times number of pages to be processed \times 1.5 .$$

In step S1907, the license request processing unit 206 adds the license valid term Tlim to the present time and calculates the expiry date of the license. Moreover, the license request processing unit 206 updates the record (the license detailed information) of the license description table 701 of the license management table 700 (FIG. 4C), which has been extracted in step S1903, with the calculated expiry date.

In step S1908, the license request processing unit 206 replies to the license extension request by giving an instruction for issuing the requested license corresponding to the license ID acquired in step S1901, to the license issuing unit 202. The license issuing instruction includes the license ID acquired in step S1901, the expiry date, the request host included in the license request return packet, and information about the processing block.

If it is determined that the license maximum value is equal to or greater than the number of licenses in use (Yes in step S1904), the license issuing instruction includes the expiry date calculated in step S1907 (the re-calculated expiry date) as the expiry date. On the other hand, if it is determined that the license maximum value is neither equal to nor greater than the number of licenses in use (No in step S1904), the license issuing instruction includes the expiry date acquired in step S1903 (i.e., the original (not re-calculated) expiry date).

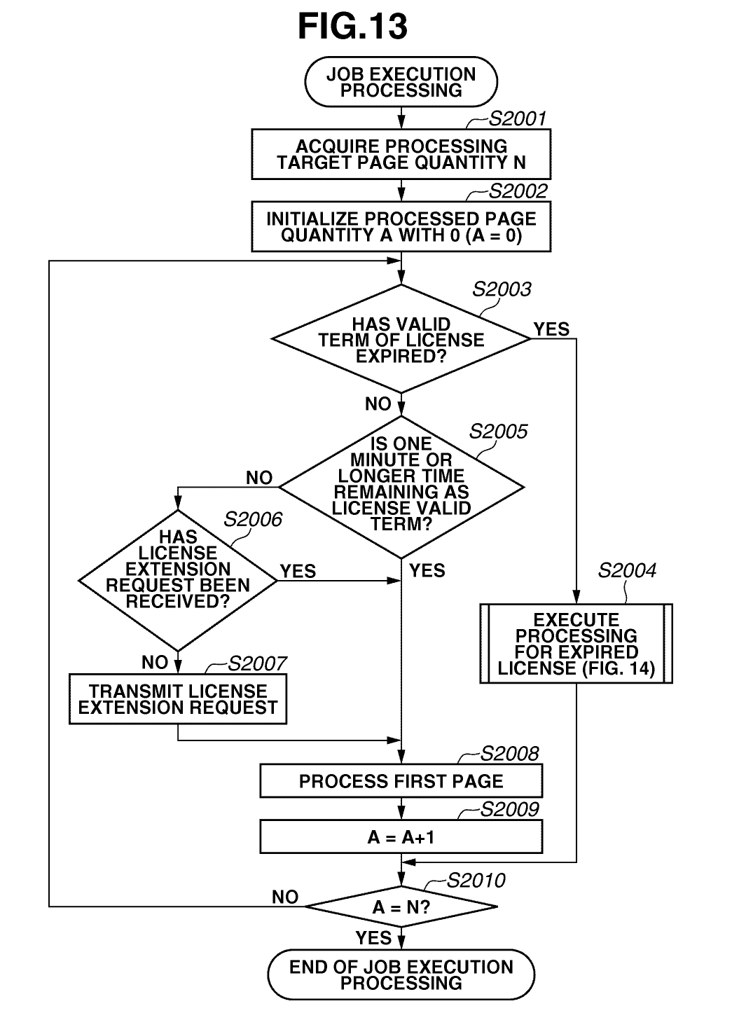

Now, job execution processing according to the present exemplary embodiment will be described in detail below with reference to FIG. 13. Processing in the flowchart of FIG. 13 is implemented by the CPU 1203 loading and executing the computer-executable program from the ROM 1202.

Referring to FIG. 13, processing in steps S2001 through S2002 is similar to the processing in steps S1501 through S1502 illustrated in FIG. 9. Accordingly, the detailed description thereof will not be repeated here.

In step S2003, the CPU 1203 compares the expiry date included in the license information (the license packet 1000), which has been acquired from the SC 101 as the license, with the present time to determine whether the valid term of the license has expired. If it is determined that the valid term of the license has expired (Yes in step S2003), then the processing advances to step S2004. In step S2004, the CPU 1203 executes expired-license processing (FIG. 14). Then the processing advances to step S2010. The expired-license processing will be described in detail below with reference to FIG. 14.

On the other hand, if it is determined that the valid term of the license has not expired yet (No in step S2003), then the processing advances to step S2005. In step S2005, the CPU 1203 determines whether one minute or longer time remains before the expiry of the valid term of the license. In the present exemplary embodiment, the threshold time of one minute is used. However, the present exemplary embodiment is not limited to this. More specifically, the threshold time can be arbitrarily set by the user. Alternatively, the threshold time can be automatically set if the remaining time is equal to or shorter than average time for acquiring a license.

If it is determined that time of one minute or longer does not remain before the expiry of the valid term of the license (if only less than one minute remains before the expiry of the license) (No in step S2005), then the processing advances to step S2006. In step S2006, the CPU 1203 determines whether the license extension request packet (FIG. 11) has been transmitted to the SC 101. If it is determined that the license extension request packet (FIG. 11) has not been transmitted to the SC 101 yet (NO in step S2006), then the processing advances to step S2007.

In step S2007, the CPU 1203 generates the license extension request packet and transmits the generated license extension request packet to the SC 101 serving as a management apparatus. Then the processing advances to step S2008.

To paraphrase this, when the remaining valid term of the license for executing a job becomes equal to or less than predetermined time (in the present exemplary embodiment, shorter than one minute) while the job is currently executed, the MFP 102 issues a request for extending the valid term of the license to the SC 101.

On the other hand, if it is determined that the license extension request packet (FIG. 11) has been already transmitted to the SC 101 (Yes in step S2006), then the processing advances to step S2008. The processing in steps S2006 and S2007 is executed to prevent consecutive inputs of an extension request for the same license. Processing in steps S2008 through S2010 is similar to the processing in steps S1507 through S1509 illustrated in FIG. 9. Accordingly, the detailed description thereof will not be repeated here.

Now, the processing in step S2004 (FIG. 13), which is executed for an expired license, will be described in detail below with reference to a flow chart of FIG. 14. Processing in the flow chart of FIG. 14 is implemented by the CPU 1203 loading and executing the computer-executable program from the ROM 1202.

Referring to FIG. 14, in step S2101, the CPU 1203 acquires the non-license operation mode M, which has been latched on the RAM 1204 and which has been instructed by the SC 101. In step S2102, the processing is branched according to the value of the non-license operation mode M.

More specifically, in step S2102, if a value “002” has been set as the value of the non-license operation mode M (“002” in step S2102), then the processing advances to step S2103. In step S2103, the CPU 1203 sets the operation mode of the MFP to a low-speed processing mode (second operation mode). Then the processing advances to step S2104. The setting of the low-speed processing mode can be implemented by a change of setting, which lowers the clock from a phase-locked loop (PLL) supplied to the CPU 1203 or decreases the rotation speed of a motor for conveying the recording paper during printing by the printer unit 1213.

On the other hand, if a value “001” has been set as the value of the non-license operation mode M (i.e., if it is determined that the normal operation mode (first operation mode) has been set for the processing of the job) (“001” in step S2102), then the processing directly advances to step S2104. Subsequent processing in steps S2104 and S2105 is similar to the processing in steps S1507 and S1508 illustrated in FIG. 9. Accordingly, the detailed description thereof will not be repeated here. However, if the low-speed operation mode has been set, the processing speed of the processing of the job may decrease.

After the processing in step S2105 is completed, the CPU 1203 returns to the main processing (i.e., the CPU 1203 returns to the processing in the flow chart of FIG. 13).

If a value “003” has been set as the value of the non-license operation mode M (i.e., if it is determined that the operation suspension (inhibition) mode (third operation mode) has been set) (“003” in step S2102), then the processing advances to step S2106. In step S2106, the CPU 1203 discontinues the power supply to the processing block and shifts the state of the MFP 102 to the job receiving state 1302. In step S2107, the CPU 1203 inputs a license re-issuing request.

To input a license re-issuing request, at first, the CPU 1203 returns the currently held license. Then the CPU 1203 transmits the license request return packet 800 (FIG. 2B), to which the number of remaining pages to be processed and the number of necessary processing blocks have been set, to the SC 101 again.

In step S2108, the CPU 1203 shifts the state of the MFP 102 to the job receiving state 1302. In addition, the CPU 1203 determines whether the threshold time for shifting to the low power state 1301, which has been notified from the SC 101, has elapsed after shifting to the job receiving state 1302.

If it is determined that the threshold time for shifting to the low power state 1301 has elapsed after shifting to the job receiving state 1302 (Yes in step S2108), then the processing advances to step S2109. In step S2109, the CPU 1203 shifts the state of the MFP 102 to the low power state 1301.

In step S2110, the CPU 1203 maintains the low power state 1301 until the trigger signal becomes “on” (i.e., until the license packet is received or until another job is input). In other words, in step S2110, the CPU 1203 determines whether the trigger signal becomes “on”.

If the trigger signal becomes “on” because the license packet has been received or because another job has been input (Yes in step S2108), then the processing advances to step S2112. In step S2112, the CPU 1203 determines whether the license given by the SC 101 has been already acquired. If it is determined that the license given by the SC 101 has not been acquired yet (No in step S2112), then the processing returns to step S2108.

On the other hand, if it is determined that the license given by the SC 101 has been already acquired (Yes in step S2112), then the processing advances to step S2113. In step S2113, the CPU 1203 resumes the supply of power to the necessary processing block according to the acquired license. Then the CPU 1203 returns to the main processing illustrated in FIG. 13.

By executing the above-described processing, the present exemplary embodiment can prevent the expiration of a license and can reduce the processing wait time for the user.

In the above-described first and the second exemplary embodiments, all the processing blocks are managed by a common upper limit value, according to a predetermined upper limit value. However, different functions may be utilized in different environments.

More specifically, a long wait time may be permitted for a specific function. On the contrary, in another case, no long wait time can be permitted. In this case, the user convenience can be increased if an upper limit value is set to each processing block and managed, according to the highest of the upper limit values for each processing block.

In the above-described exemplary embodiments, the processing of the job cannot be started until all the licenses requested by the MFPs 102 are given. However, if the upper limit value of the number of licenses can be set different for each processing block, the availability of the license may differ for different processing blocks. Accordingly, in this case, the licenses that enable the processing of a job may not be acquired at the same time in a lump.

Accordingly, the throughput of the entire system can be improved if the MFP 102 can serially process, by divided processing, a part of the job even if not all the licenses have been acquired. A third exemplary embodiment of the present invention can execute the management and the divided processing for each processing block according to the upper limit value of the number of available licenses.

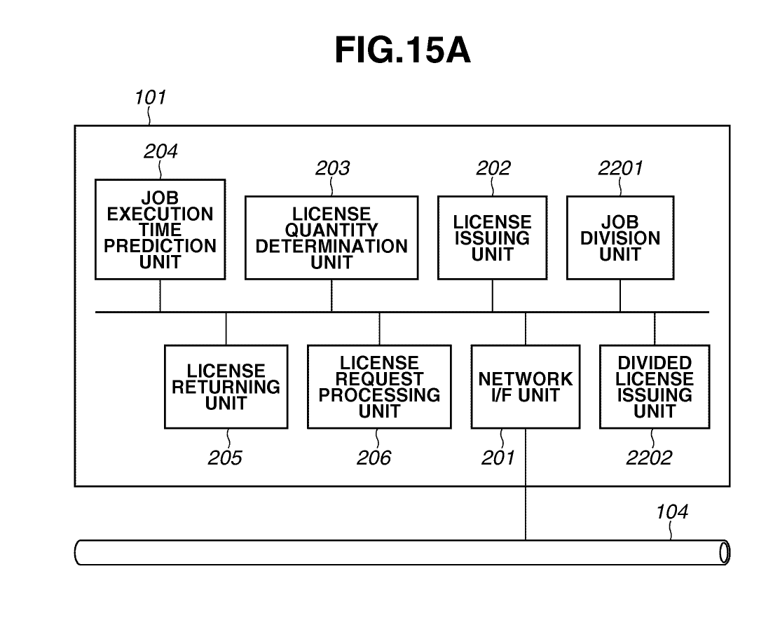

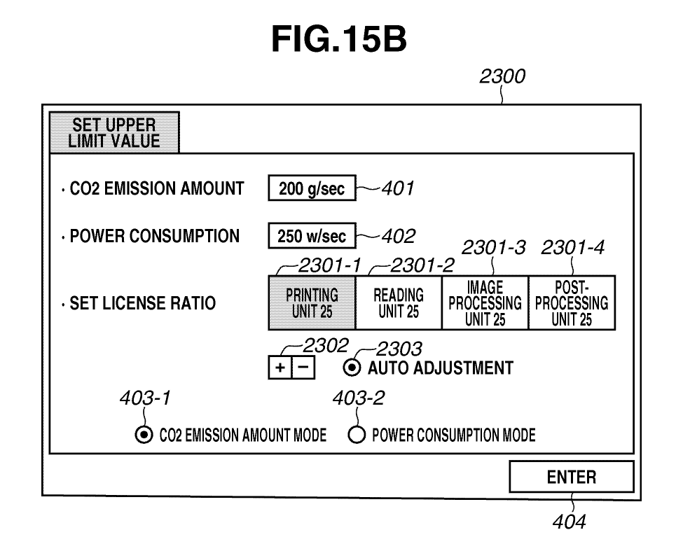

FIG. 15A illustrates an exemplary inner configuration of the SC 101 according to the present exemplary embodiment. The blocks that are similar to those illustrated in FIG. 1B are provided with the same reference numerals and symbols. Accordingly, the detailed description thereof will not be repeated here.

Referring to FIG. 15A, the SC 101 includes a job division unit 2201. The job division unit 2201 divides a job into the unit of a step if all the licenses requested by the MFPs 102 cannot be given by batch processing. A divided license issuing unit 2202 issues a license for executing each divided step that has been divided by the job division unit 2201.

In the present exemplary embodiment, the license quantity determination unit 203 can set the upper limit value to each processing unit. The upper limit value can be set via a screen 2300 illustrated in FIG. 15B on a display screen of the SC 101, which is the management apparatus.

FIG. 15B illustrates an example of the screen for determining the license maximum value according to the present exemplary embodiment. In the example illustrated in FIG. 15B, portions similar to those of the screen 400 illustrated in FIG. 3 are provided with the same reference numerals and symbols.

Referring to FIG. 15B, keys 2301-1 through 2301-4 are operated by the user to select the processing block whose ratio of license is to be changed. The user can select either one of the keys 2301-1 through 2301-4. If any of the keys 2301-1 through 2301-4 is selected, the selected key is displayed in a reversed state to enable the user to uniquely identify the currently selected processing block.

Each of the keys 2301-1 through 2301-4 displays the ratio of the license of each processing block. In the example illustrated in FIG. 15B, each processing block has the license ratio of 25%.

Keys 2302 can be operated to adjust the license ratio to be assigned to each processing block. After selecting any of the keys 2301-1 through 2301-4, the user can raise the ratio assigned to the selected processing block by pressing the “+” key 2302 while the user can lower the license ratio assigned to the selected processing block by pressing the “-” key 2302.

If the sum of the assigned ratios exceeds “100” (or “0”) by the setting of the user, a warning message is presented to the user. Accordingly, the user is required to appropriately adjust the ratio of the other processing blocks or cancel the adjustment of the license ratio to the selected processing block in this case.

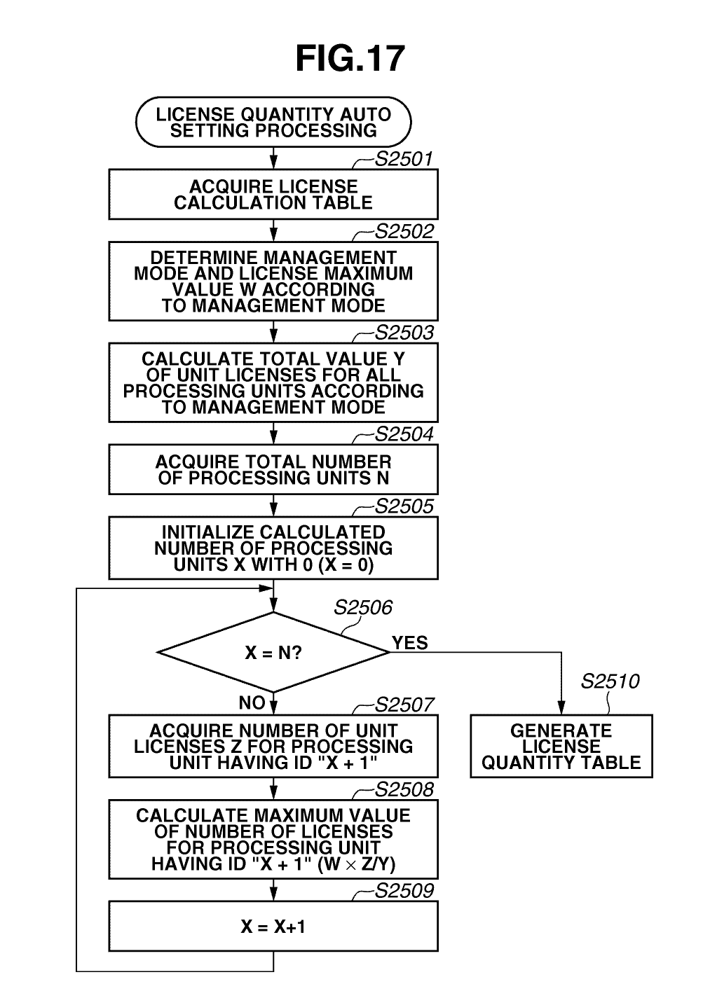

A selection switch 2303 can be operated to instruct automatic adjustment. If the user has operated the switch 2303 to select the automatic adjustment, the CPU 1203 refers to the license calculation table 300 (FIG. 2A) and executes automatic license assignment setting processing (FIG. 17) for automatically assigning and setting the license ratio according to the ratio of power consumption by each processing block or the ratio of CO₂ emission amount of each processing block.

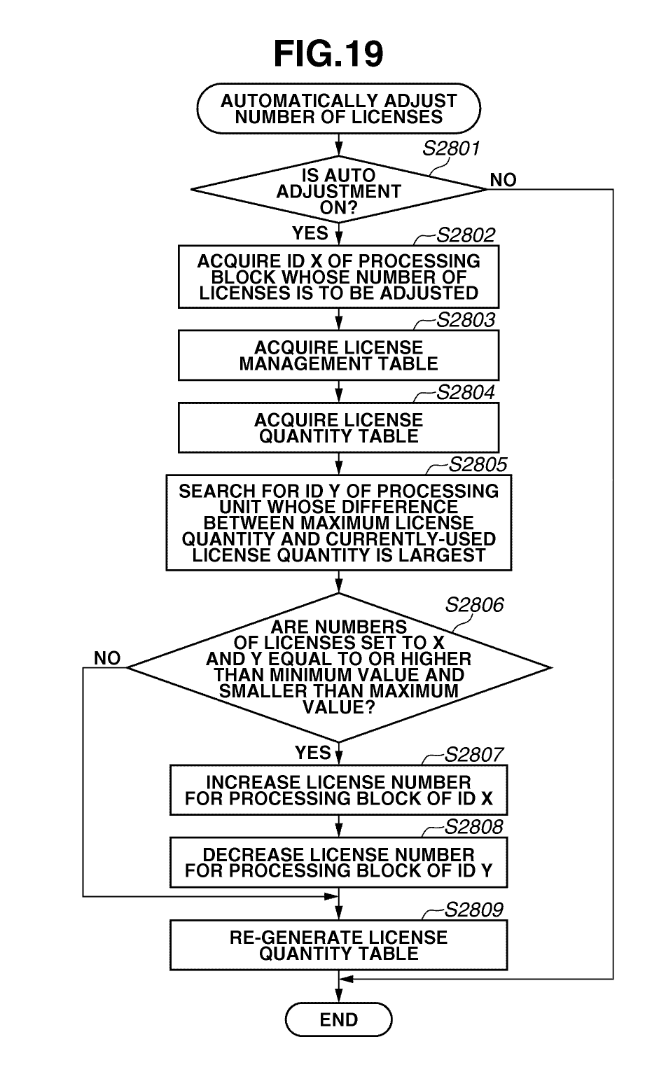

If the user has selected the automatic adjustment by operating the switch 2303, the CPU 1203 also executes license quantity adjustment processing (FIG. 19) for automatically increasing or decreasing the ratio of a processing block whose availability is high within a range in which the total of the license ratios of the processing blocks is not changed.

In the present exemplary embodiment, if a user instruction via the enter button 404 has been detected, the license quantity determination unit 203 determines the license maximum value according to the upper limit value corresponding to the management mode that has been selected by operating the switch 403-1 or 403-2. In addition, the license quantity determination unit 203 determines the license maximum value for each processing block according to the license ratio of each processing block displayed on the keys 2301-1 through 2301-4.

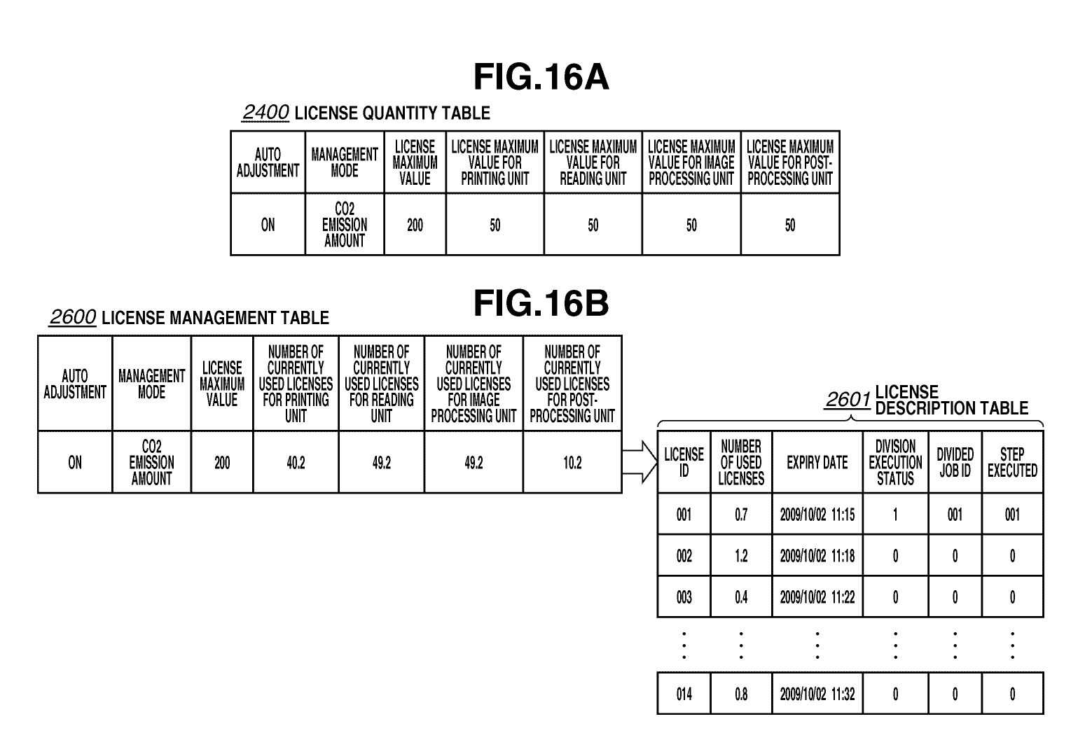

More specifically, the license quantity determination unit 203 determines the license maximum value for each of the printer unit, the reading unit, the image processing unit, and the post-processing unit. The determined license maximum value and the license maximum value for each processing block determined in the above-described manner are stored on the RAM of the SC 101 as a license quantity table 2400 (FIG. 16A).

Referring to FIG. 16A, to an automatic adjustment field of the license quantity table 2400, the license maximum value is set independently for each processing block. In addition, to an automatic adjustment field of the license quantity table 2400, information about whether the automatic adjustment has been set to be ON or OFF by operating the selection switch 2303 is set.

Now, the license automatic assignment setting processing will be described in detail below with reference to FIG. 17. Processing illustrated in FIG. 17 is executed by the license quantity determination unit 203 (the CPU of the SC 101).

Referring to FIG. 17, in step S2501, the license quantity determination unit 203 acquires the license calculation table 300 (FIG. 2A). In step S2502, the license quantity determination unit 203 determines the management mode input via the screen 2300 and the upper limit value of the license (a license maximum value W) according to the input management mode.

In step S2503, the license quantity determination unit 203 calculates a unit license total Y, which is the total number of licenses of all the processing blocks, from the license calculation table 300 (FIG. 2A) according to the management mode acquired in step S2502. For example, if the user has selected the control switch 403-1 to select the CO₂ emission amount management mode via the screen 2300, the license quantity determination unit 203 combines only the processing block unit licenses related to the CO₂ emission amount acquired from the license calculation table 300 (FIG. 2A). The result of the combination is set as the unit license total Y.

In step S2504, the license quantity determination unit 203 acquires the total number of the processing blocks (the number of the processing units N). In the present exemplary embodiment, the number of the processing units N is “4”, corresponding to the printer unit, which has a processing unit ID “0”, a reading unit, which has a processing unit ID “1”, an image processing unit, which has a processing unit ID “3”, and a post-processing unit, which has a processing unit ID “3”. Accordingly, a value “4” is set to the number of processing units N. It is supposed that the number of processing blocks and the processing unit ID of each processing unit are previously set by the administrator on the external memory of the SC 101.

In step S2505, the license quantity determination unit 203 initializes the number X of the processing units whose license quantity upper limit value has been calculated, with “0”. In step S2506, the license quantity determination unit 203 compares the number X of the processing units whose license quantity upper limit value has been calculated, with the number of the processing units N. In other words, in step S2506, the license quantity determination unit 203 determines whether the license quantity upper limit value has been calculated for all the processing units (i.e., the license quantity determination unit 203 determines whether X=N).

If it is determined that the license quantity upper limit value has not been calculated for all the processing units yet (X≠N) (No in step S2506), then the processing advances to step S2507. In step S2507, the license quantity determination unit 203 calculates the total Z of unit licenses of processing blocks whose processing unit ID is “X+1” from the license calculation table 300 (FIG. 2A) according to the management mode acquired in step S2502.

In step S2508, the license quantity determination unit 203 calculates the license quantity maximum value of the processing block having the processing unit ID “X+1” based on the license maximum value W and the ratio of the total Z of the unit licenses of the processing block having the processing unit ID “X+1” to the unit license total Y of all the processing units. The calculated license quantity maximum value is stored on the memory.

In the present exemplary embodiment, the license quantity maximum value of the processing block having the processing unit ID “X+1” can be calculated by the following expression:

license quantity maximum value=W×Z/Y.

However, the license quantity maximum value of the processing block having the processing unit ID “X+1” can be calculated by assigning a different weight. Alternatively, the above-described ratio can be calculated by using an average value of the number of unit licenses for the processing blocks of each MFP.

In step S2509, the license quantity determination unit 203 increments the processing unit ID by 1. Then the processing returns to step S2506. The license quantity determination unit 203 repeats the processing in step S2506 until the number of licenses is completely calculated for all the processing blocks. To paraphrase this, in step S2506, the license quantity determination unit 203 determines whether the license maximum value has been already calculated for all the processing units (whether X=N).

If it is determined that the license quantity upper limit value has been already calculated for all the processing units (X=N) (Yes in step S2506), then the processing advances to step S2510. In step S2510, the license quantity determination unit 203 generates the license quantity table 2400 (FIG. 16A) by using the license quantity upper limit value for each processing block, which has been stored on the memory. Then the license automatic assignment setting processing ends.

In the present exemplary embodiment, the license request processing unit 206 generates a license management table 2600 (FIG. 16B) based on the license quantity table 2400 (FIG. 16A) and stores the generated license management table 2600.

Referring to FIG. 16B, the number of licenses in use is stored in the license management table 2600 according to the present exemplary embodiment for each processing block. In addition, automatic adjustment setting information (whether automatic adjustment has been set on by the user operating the switch 2303 via the screen 2300) is stored in an automatic adjustment field of the license management table 2600.

A license description table 2601 includes a division execution field, which stores information that indicates whether the division is currently executed. In addition, the license description table 2601 includes a divided job ID field and an executed step field. The fields of the license description table 2601 will be described in detail below.

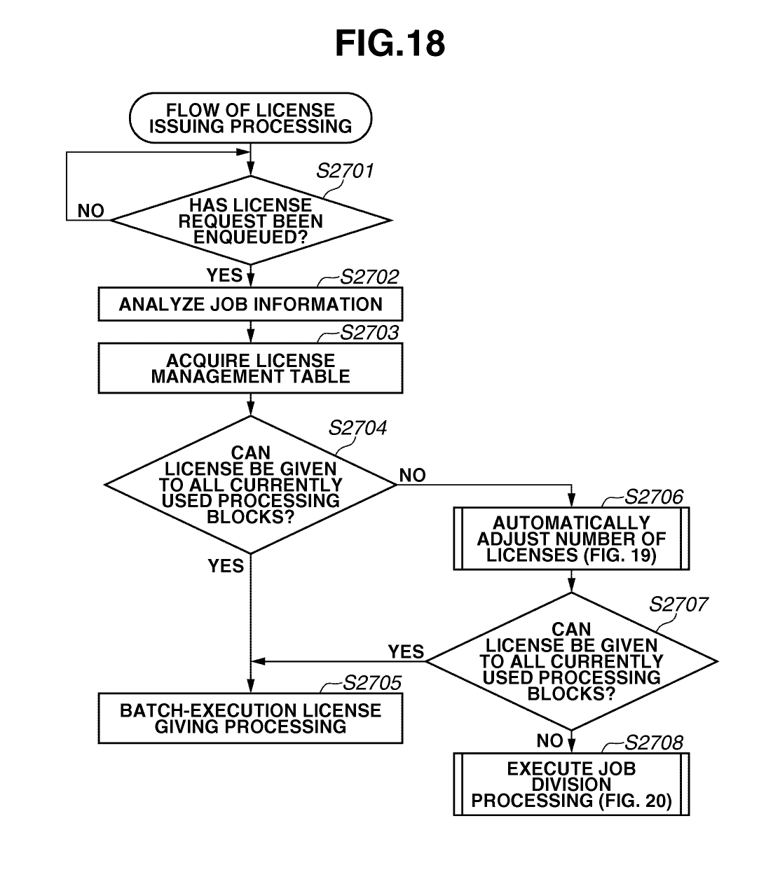

Now, license issuing request processing according to the present exemplary embodiment will be described in detail below with reference to FIG. 18. Processing in the flow chart of (FIG. 8) is executed by the license request processing unit 206 (the CPU of the SC 101). The basic processing flow of the processing illustrated in FIG. 18 is similar to the license issuance request processing according to the first exemplary embodiment described above.

Referring to FIG. 18, in step S2701, the license request processing unit 206 determines whether a license request packet has been enqueued in the processing queue. If it is determined that a license request packet has been enqueued in the processing queue (Yes in step S2701), then the processing advances to step S2702. In step S2702, the license request processing unit 206 analyzes the job information. In step S2703, the license request processing unit 206 acquires the license management table 2600 (FIG. 16B).

In step S2704, the license request processing unit 206 determines whether a license can be given to all the processing blocks used in the job. If it is determined that a license can be given to all the processing blocks used in the job (Yes in step S2704), then the processing advances to step S2705. In step S2705, the license request processing unit 206 executes license issuing batch processing.

In the license issuing batch processing in step S2705, the license request processing unit 206 calculates the license valid term by executing processing similar to the processing in step S908 through S911 illustrated in FIG. 5. In addition, the license request processing unit 206 updates the license management table 2600 (FIG. 16B). Furthermore, the license request processing unit 206 inputs a license issuance instruction to the license issuing unit 202.

In updating the license management table 2600 (FIG. 16B), the license request processing unit 206 updates the number of licenses in use for each processing block. In addition, the license request processing unit 206 sets a value “0” to each of the division execution field and the already-executed step field of the license description table 2601. Furthermore, the license request processing unit 206 sets the parameter value “0” to the divided job ID field.

On the other hand, if it is determined that a license cannot be given to at least one processing block used in the job (No in step S2704), then the processing advances to step S2706. In step S2706, the license request processing unit 206 inputs an instruction to the license quantity determination unit 203 for executing the automatic adjustment of the number of licenses.

In other words, the license request processing unit 206 instructs the license quantity determination unit 203 to automatically adjust the number of licenses if the number of licenses in use of one or more processing blocks exceeds the license maximum value when the license is issued. After receiving the instruction from the license request processing unit 206, the license quantity determination unit 203 executes the license quantity automatic adjustment processing illustrated in FIG. 19.

After the license quantity automatic adjustment processing is completed, the processing advances to step S2707. In step S2707, the license request processing unit 206 determines whether a license can be given to all the processing blocks to be used in the job as a result of the automatic adjustment in step S2706.

If it is determined that a license can be given to all the processing blocks to be used in the job (Yes in step S2707), then the processing advances to step S2705. In step S2705, the license request processing unit 206 executes the above-described license issuing batch processing.

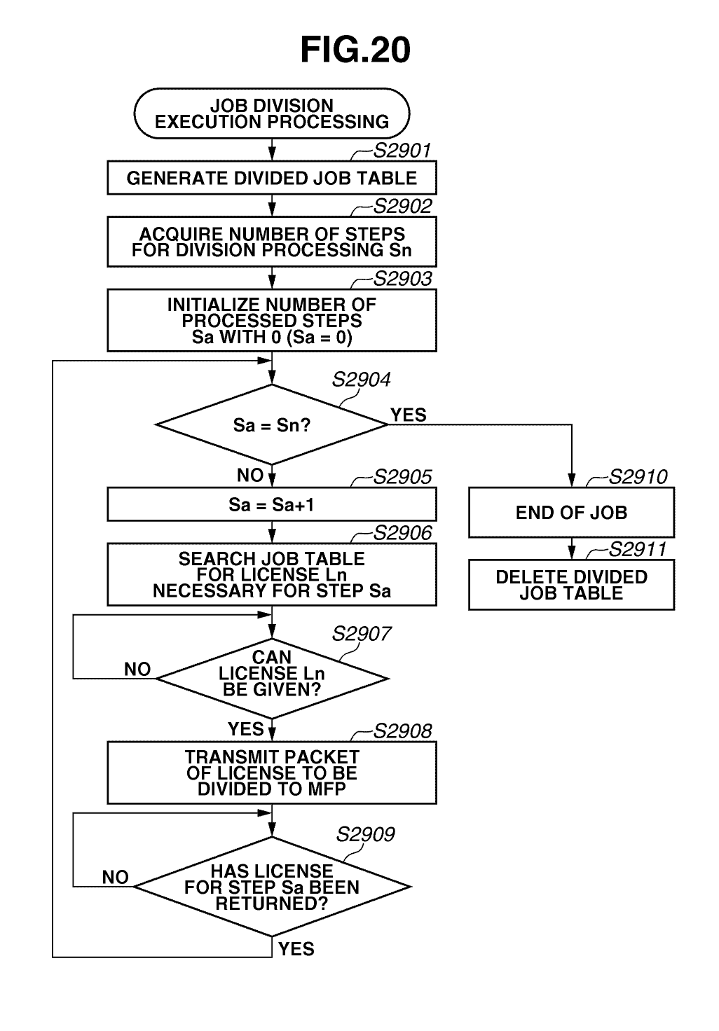

On the other hand, if it is determined that a license cannot be given to one or more processing blocks even after the automatic adjustment in step S2706 (No in step S2707), then the processing advances to step S2708. In step S2708, the license request processing unit 206 instructs the job division unit 2201 to execute divided-job-execution processing illustrated in FIG. 20.

Now, the license quantity automatic adjustment processing in step S2706 (FIG. 18) will be described in detail below with reference to FIG. 19. Processing in FIG. 19 is executed by the license quantity determination unit 203 (the CPU of the SC 101).

Referring to FIG. 19, in step S2801, the license quantity determination unit 203 determines whether a parameter value “ON” has been set to the automatic adjustment field of the license management table 2600 (FIG. 16B). If it is determined that a parameter value “ON” has not been set to the automatic adjustment field of the license management table 2600 (FIG. 16B) (No in step S2801), then the processing returns to the processing in the flow chart of FIG. 18 without re-generating the license quantity table 2400 (FIG. 16A).

On the other hand, if it is determined that a parameter value “ON” has been set to the automatic adjustment field of the license management table 2600 (FIG. 16B) (Yes in step S2801), then the processing advances to step S2802. In step S2802, the license quantity determination unit 203 acquires a parameter value “X”, which indicates the processing unit ID of the processing unit for which a request for licenses in the number exceeding the license quantity upper limit value has been input. If a plurality of processing blocks exists for which a request for licenses in the number exceeding the license quantity upper limit value has been input, the license quantity determination unit 203 acquires the processing unit ID of any of such processing blocks.

In step S2803, the license quantity determination unit 203 acquires the license management table 2600 (FIG. 16B). In step S2804, the license quantity determination unit 203 acquires the license quantity table 2400 (FIG. 16A).

In step S2805, the license quantity determination unit 203 determines an ID Y, which is an ID of the processing block whose value calculated by subtracting the number of licenses in use from the maximum number of licenses is the greatest of the blocks having the processing unit ID different from “X”.

In step S2806, the license quantity determination unit 203 determines whether each number of licenses set as the values X and Y does not exceed the range between the upper limit value and a lower limit value determined within the system (i.e., whether the number of licenses set to the values X and Y is equal to or greater than the lower limit value and below the maximum value).

The upper limit value (the maximum value) and the lower limit value (the minimum value) are previously determined according to the value set by the user or the format of the license and are previously stored on the external memory of the SC 101. If both the numbers of licenses set to the values X and Y are within the upper limit value and the lower limit value (i.e., equal to or greater than the minimum value and below the maximum value) (Yes in step S2806), then the processing advances to step S2808.

In steps S2807 and S2808, the license quantity determination unit 203 increments the number of licenses for the processing block whose processing block ID is “X” and decrements the number of licenses of the processing block having the processing unit (block) ID “Y”. Then the processing advances to step S2809.

The license quantity determination unit 203 can increment or decrement the number of licenses by a predetermined value (for example, “1”). Alternatively, in step S2808, the license quantity determination unit 203 can increment or decrement the number of licenses by a value previously set by the user and having been previously stored on the external memory of the SC 101.

On the other hand, if it is determined that at least one of the numbers of licenses set to the values X and Y exceeds the upper limit value or the lower limit value determined within the system (i.e., if at least one of the numbers of licenses set to the values X and Y is below the minimum value or equal to or greater than the maximum value) (No in step S2806), then the processing advances to step S2809.

In step S2809, the license quantity determination unit 203 re-generates the license quantity table 2400 (FIG. 16A). Then the license automatic adjustment processing ends.

Now, the divided-job-execution processing in step S2708 (FIG. 18) will be described in detail below with reference to FIG. 20. In the processing in the flow chart of FIG. 20, processing in step S2901 is executed by the job division unit 2201 while processing in steps S2902 through 2911 is executed by the divided license issuing unit 2202. To paraphrase this, the processing in the flow chart of FIG. 20 is executed by the CPU of the SC 101.

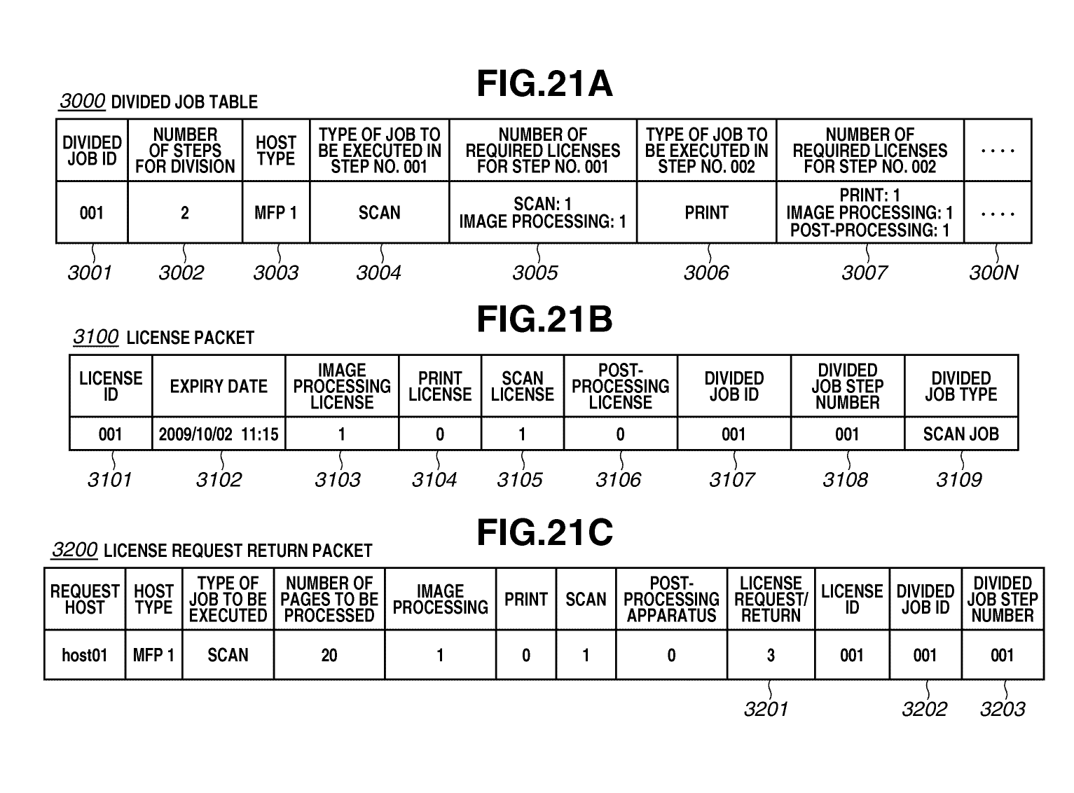

Referring to FIG. 20, in step S2901, the job division unit 2201 generates a divided job table 3000 (FIG. 21A), which is used for executing each divided job. Referring to FIG. 21A, the divided job table 3000 (FIG. 21A) includes an ID 3001, which is an ID for identifying a divided job. Divided job IDs, each of which is uniquely assigned to a divided job, are generated in order of generation thereof and are assigned to the divided jobs.

A divided step quantity field 3002 stores the number of the divided steps of the job. According to the number of the steps, in the fields 3004 through 300N (N is an integer) the step number and the number of licenses necessary for the step are stored. An ID 3003 is used for uniquely identifying each host. The ID 3003 is used to determine whether the licenses in the requested number can be given.

The fields 3004 through 300N record the type of job to be executed in each step when each step is executed and the number of necessary licenses. If the step has been divided into N steps, N combinations of the field for the type of job to be executed and the field for the number of necessary licenses are generated. In the example illustrated in FIG. 21A, a copy job is divided into two jobs including a scan job for reading an image of a document and a print job for printing the read document image.

Returning to the description of the processing illustrated in the flow chart of FIG. 20, after generating the divided job table 3000, the job division unit 2201 transfers the generated divided job table 3000 to the divided license issuing unit 2202. When the divided job table 3000 is received, in step S2902, the divided license issuing unit 2202 acquires a number of divided steps Sn. The number of divided steps Sn can be acquired by referring to the divided step quantity field of the divided job table 3000.

In step S2903, the divided license issuing unit 2202 initializes a number of already-executed steps Sa with a value “0”. In step S2904, the divided license issuing unit 2202 compares the number of already-executed steps Sa with the number of divided steps Sn. If it is determined that Sa and Sn are different from each other (Sa≠Sn) (No in step S2904), then the processing advances to step S2905. In step S2905, the divided license issuing unit 2202 increments the number of already-executed steps Sa by 1.

In step S2906, the divided license issuing unit 2202 acquires information about the step for the number of already-executed steps Sa. In addition, the divided license issuing unit 2202 calculates a number of necessary licenses Ln by referring to the divided job table 3000 for a host type 3003 and the step number based on the information stored in the license calculation table 300 (FIG. 2A).

More specifically, if the number of already-executed steps Sa has a value “1”, in the example illustrated in FIG. 21A, the host type field 3003 has a parameter value “MFP 1” and a “type of job to be executed in step No. 001” field has a parameter value “scan: 1/image processing: 1”. Accordingly, the number of necessary licenses Ln becomes “0.4” for the license for the reading unit and “0.1” for the license for the image processing unit.

In step S2907, the divided license issuing unit 2202 determines whether the number of necessary licenses Ln for the step for the number of already-executed steps Sa can be given. If it is determined that the number of necessary licenses Ln for the step for the number of already-executed steps Sa can be given (Yes in step S2907), then the processing advances to step S2908.

In step S2908, the divided license issuing unit 2202 generates a license packet 3100, which will be described in detail below with reference to FIG. 21B, and transmits the license packet 3100 to the MFP 102 that has input the license request. At the same time, the divided license issuing unit 2202 updates the information stored in the license description table 2601 of the license management table 2600 (FIG. 16B).

More specifically, if Sa=1, then the divided license issuing unit 2202 newly registers divided license information in the license description table 2601. On the other hand, if Sa≠1, then the divided license issuing unit 2202 updates the information included in the record to which the divided job ID stored in the license description table 2601 corresponds, such as the number of licenses to be used and the expiry date.

In step S2909, the license request processing unit 206 examines the already executed step, which is stored in the record to which the divided job ID in the license description table 2601 of the license management table 2600 (FIG. 16B) corresponds, and waits until the step for the number of already-executed steps Sa is executed.

If it is determined that the step for the number of already-executed steps Sa has been executed (Yes in step S2909), the license request processing unit 206 returns the processing to step S2904 to execute a next step. If it is determined that the number of already-executed steps Sa and the number of divided steps Sn are equal to each other (Yes in step S2904), the license request processing unit 206 determines that all the steps have been completely executed. Then the processing advances to step S2910.

In step S2910, the license request processing unit 206 ends the processing of the job. In step S2911, the license request processing unit 206 deletes the divided job table for the divided job that has been completely executed. Then the divided job-execution processing ends.

In the present exemplary embodiment, the license packet 3100 has a structure illustrated in FIG. 21B. More specifically, the license packet 3100 according to the present exemplary embodiment includes a divided job ID 3107 and a divided job step number 3108, and a divided job type 3109 in addition to the fields of the license packet 1000 (FIG. 2C) described above in the first exemplary embodiment. Fields 3101 through 3106 are similar to the fields 1001 through 1006 of the license packet 1000 (FIG. 2C) for the batch processing.

A divided job ID, which is stored in the divided job table 3000, is set to the divided job ID 3107. A step number of the job to be divided and executed by the instruction from the SC 101 is set to the divided job step number field 3108. A type of the job to be executed by the instruction from the SC 101 is set to the divided job type field 3109. The license packet 3100, which includes the above-described information, is transmitted to the MFP 102.

A license request return packet 3200 has a structure illustrated in FIG. 21C. The license request return packet is used to return a divided license. Every time a step is completed, the MFP 102 transmits the license request return packet 3200 (FIG. 21C) to the SC 101.

FIG. 21C illustrates an exemplary structure of the license request return packet 3200 according to the present exemplary embodiment.

The license request return packet 3200 according to the present exemplary embodiment is different from the license request return packet 800 (FIG. 2B) according to the first exemplary embodiment in the following points. More specifically, a parameter value “3”, which indicates that the license for executing the divided job is to be returned, is set in a “license request/return” field 3201. In addition, the license request return packet 3200 according to the present exemplary embodiment includes a divided job ID 3202 and a divided job step number 3203, which have been provided based on the license for executing the divided job.

When a packet having a parameter value “3” set to the license request/return field 3201 is received by the SC 101, the SC 101 updates the information stored in the license description table 2601 of the license management table 2600 (FIG. 16B). Furthermore, the SC 101 sets the divided job step number included in the returned packet to the number of already-executed steps field. If the number of already-executed steps has been changed, it can be determined that the license has been returned in step S2909 (FIG. 20).

After completing all the steps, the MFP 102 generates the license request return packet 800 (FIG. 2B) for returning normal licenses and transmits the generated license request return packet 800 (FIG. 2B) to the SC 101.

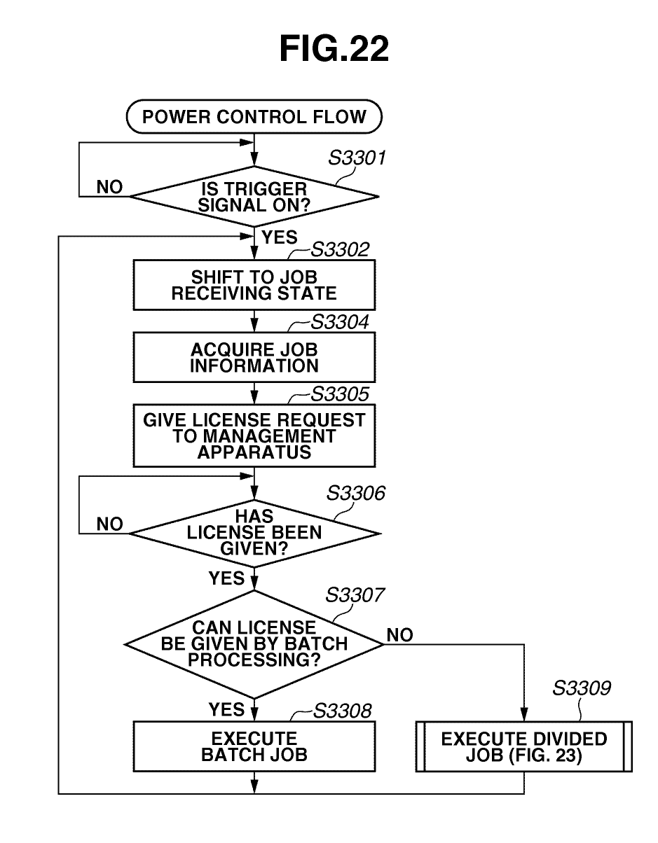

Now, the job execution processing, which is executed by the MFP 102, will be described in detail below with reference to FIG. 22. Processing in the flow chart of FIG. 22 is implemented by the CPU 1203 by loading and executing the computer-executable program from the ROM 1202.

In the example illustrated in FIG. 22, processing in steps S3301 through S3306 is similar to the processing insteps S1401 through S1406 illustrated in FIG. 8. Accordingly, the detailed description thereof will not be repeated here.

In step S3307, the CPU 1203 of the MFP 102 at first stores the acquired license packet 3100 (FIG. 21B) on the memory as the license information. In addition, in step S3307, the CPU 1203 determines whether the licenses can be given by batch processing according to the value stored in the divided job ID field 3107 of the license information.

If the divided job ID 3107 included in the license information has a parameter value “0”, the CPU 1203 determines that the license can be given by batch processing (Yes in step S3307). Then the processing advances to step S3308. In step S3308, the CPU 1203 executes the usual batch job (FIG. 9).

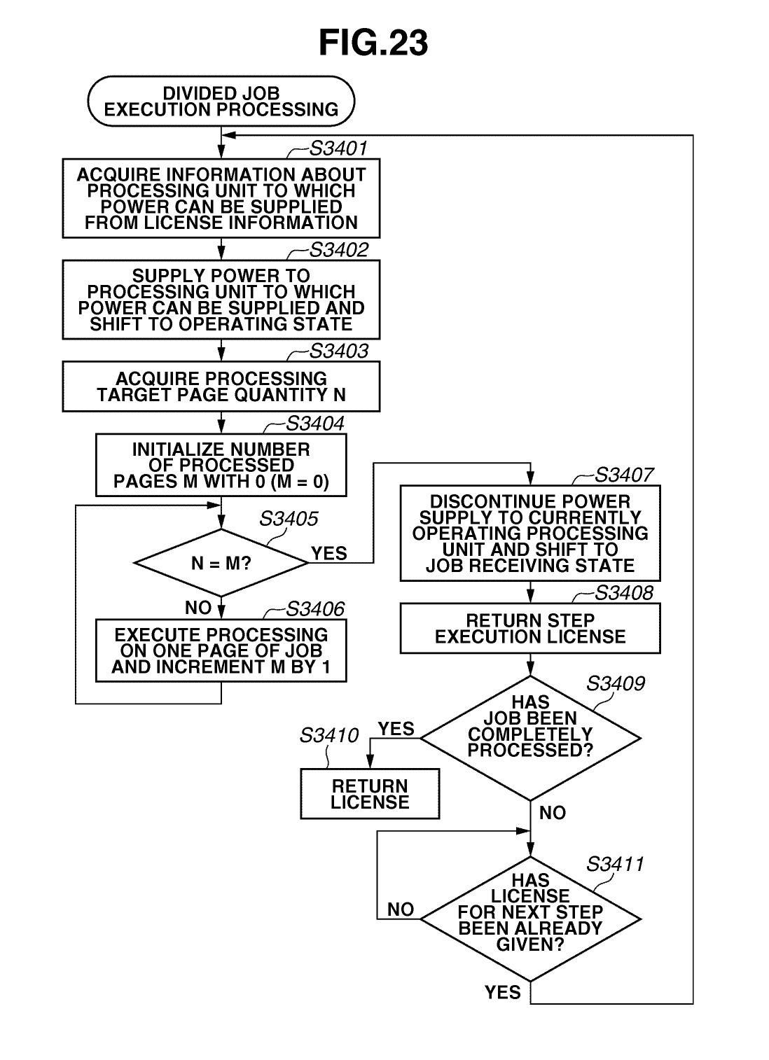

If the divided job ID 3107 included in the license information is not a parameter value “0”, the CPU 1203 determines that the license cannot be given by batch processing (No in step S3307). Then the processing advances to step S3309. In step S3309, the CPU 1203 executes the divided job execution processing, which will be described in detail below with reference to FIG. 23.

After completing the job in step S3308 or S3309, then the processing returns to step S3302. In step S3302, the CPU 1203 shifts the state of the MFP 102 to the job receiving state 1302.

Now, the divided job execution processing in step S3309 of the flow chart of FIG. 22 will be described in detail below with reference to FIG. 23. Processing in the flow chart of FIG. 23 is implemented by the CPU 1203 by loading and executing the computer-executable program from the ROM 1202.

In executing the divided jobs, in step S3401, the CPU 1203 acquires, from the license information, the information about the processing unit (processing block) to which power can be fed. In step S3402, the CPU 1203 starts the supply of power to each processing unit that corresponds to the acquired information about the processing unit (processing block) to which power can be fed.

In step S3403, the CPU 1203 acquires the processing target page quantity N. In step S3404, the CPU 1203 sets a value M as the value of the number of already processed pages. Furthermore, in step S3404, the CPU 1203 sets a parameter value “0” to the already-processed page quantity M.

In step S3405, the CPU 1203 compares the already-processed page quantity M with the processing target page quantity N and determines whether one step of the divided steps to be executed has been completed (i.e., whether M=N). If it is determined that not all the pages have been completely processed (i.e., if M≠N) (No in step S3405), then the processing advances to step S3406.

In step S3406, the CPU 1203 processes one page of the job instructed to be executed in the license information acquired in step S3401. In addition, the CPU 1203 sets a value “M+1” to the already-executed page quantity M. Furthermore, in step S3406, the CPU 1203 increments the already-executed page quantity M. Then the processing returns to step S3405.

On the other hand, if it is determined that one step of the divided steps to be executed has been completed (i.e., if it is determined that M=N) (Yes in step S3405), then the processing advances to step S3407. In step S3407, the CPU 1203 discontinues the supply of power that has been executed according to the license information. In other words, the CPU 1203 discontinues the supply of power to each processing unit (processing block) to which the supply of power has been started in step S3402.

In step S3408, the CPU 1203 returns the license for executing the step. The step execution license is returned by transmitting the license request return packet, which has a parameter value “3” set to the license request/return field 3201 (FIG. 21C) thereof, to the SC 101 in the above-described manner.

After having returned the step execution license, in step S3409, the CPU 1203 determines whether all the steps have been completely executed and whether the job has been completed. If it is determined that any step that has not been executed yet remains (that the job is not completed) (No in step S3409), then the processing advances to step S3411. In step S3411, the CPU 1203 waits until a next license for executing divided jobs is given. If it is determined that the next license for executing divided jobs has been acquired (Yes in step S3411), then the processing returns to step S3401 and the next step is executed.

On the other hand, if it is determined that all the steps have been completely executed (that the job has been completed) (Yes in step S3409), then the processing advances to step S3410. In step S3410, the CPU 1203 returns the license. The license is returned by transmitting the license request return packet, which has a parameter value “3” set to the license request/return field 3201 (FIG. 21C) thereof, to the SC 101 in the above-described manner. After returning the license, the CPU 1203 returns to the main processing in the flow chart of FIG. 22.

As described above, in the present exemplary embodiment, if the licenses for all the processing units (processing blocks) cannot be secured by batch processing, the MFP can execute divided jobs, which have been divided according to the instruction for executing divided jobs.

With the above-described configuration, the present exemplary embodiment can shorten the user wait time by reducing possibility that the user is required to wait for a license to be given. Accordingly, the present exemplary embodiment can improve the throughput of the entire system.

For example, in executing printing under a special condition, i.e., in printing a failure report or in printing a report of administration information by the system administrator, the user (administrator) may not desire to execute the control of power supplied to the device according to the license. Ina fourth exemplary embodiment of the present invention, processing executed in the above-described case will be described in detail below.

The present exemplary embodiment employs a configuration substantially similar to that of the first exemplary embodiment except the following difference points described below. In the following description, only the difference will be described in detail.

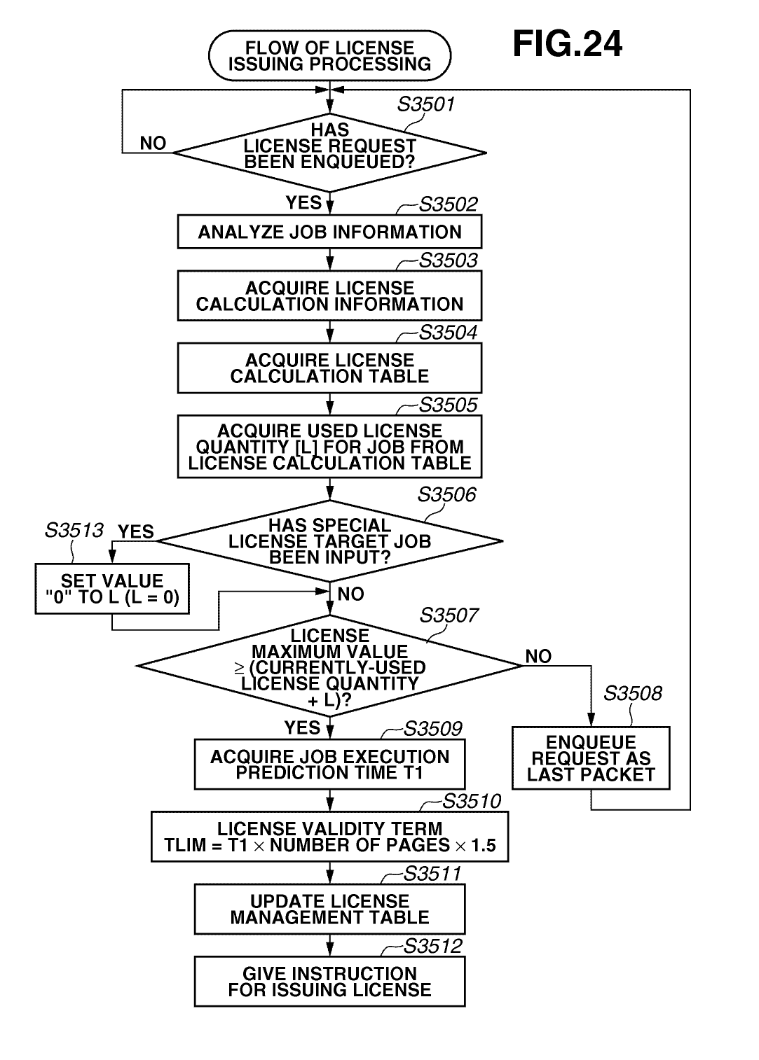

License issuing processing according to the present exemplary embodiment will be described in detail below with reference to FIG. 24. The processing illustrated in FIG. 24 is executed by the license request processing unit 206 (the CPU of the SC 101).

Referring to FIG. 24, processing in steps S3501 through S3505 is similar to the processing in steps S901 through S905 described above in the first exemplary embodiment with reference to FIG. 5. Accordingly, the detailed description thereof will not be repeated here.

In step S3506, the license request processing unit 206 determines whether the type of job to be executed, which has been identified according to the information included in the license request packet, is a special license target job that has been previously set. If it is determined that the type of job to be executed is not a special license target job (No in step S3506), then the processing advances to step S3507.

On the other hand, if it is determined that the type of job to be executed is a special license target job (Yes in step S3506), then the processing advances to step S3513. In step S3513, the license request processing unit 206 sets a parameter value “0” as the value of the available license quantity L, which has been calculated in step S3505. Then the processing advances to step S3507. Subsequent processing in steps S3507 through S3512 is substantially similar to the processing in steps S906 through S911 described above with reference to FIG. 5.

If a special license target job is to be executed, a parameter value “0” has been set as the value of the available license quantity L. Accordingly, the license request processing unit 206 determines that the available license quantity is zero regardless of which processing unit is used in the job.

Therefore, in this case, the license maximum value is always equal to or greater than the sum of the number of licenses in use and the available license quantity L (Yes in step S3507). Accordingly, the license request processing unit 206 determines that the license can be issued and issues the license. As described above, in executing a special license target job, the license is always issued.

Accordingly, in this case, the MFP 102 can surely execute the job regardless of the number of licenses the SC 101 has. In other words, if a special license target job is to be executed, the MFP 102 issues the license regardless of whether the number of licenses in use exceeds the license maximum value.

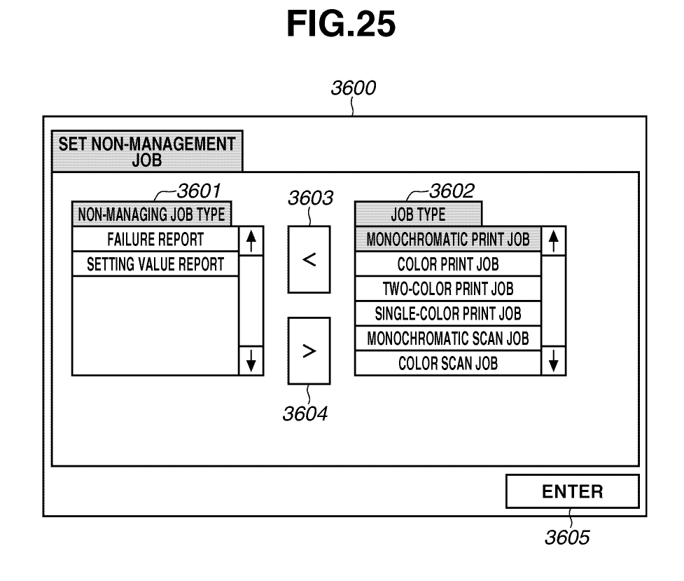

Now, a method for managing the type of a job that is input and executed under the special license according to the present exemplary embodiment will be described in detail below. An application program that operates on the SC 101 manages the type of a job that is input and executed under the special license. The application program displays a screen 3600 (FIG. 25) on the display device of the SC 101.

FIG. 25 illustrates an example of a screen for managing the type of a job input and executed under the special license (non-management job type setting screen). Referring to FIG. 25, a list 3601 stores non-management job types (special license target job types (i.e., types of jobs not to be included in licenses to be managed because the license thereof is the special license).

All the job types are displayed as a list 3602. The job type selected from the list 3602 is displayed in the reverse state. In setting the job that is displayed in the list 3602 in the reverse state (i.e., the job type selected from the list 3602b) to the non-management job type (the special license target job type), the user presses a key 3603.

By executing the operation, the job type selected from the list 3602 can be added to the list 3601 of the non-management job types (special license target job types). On the other hand, in returning the non-management job type (the special license target job type) to the management target job type, the user can select the job type from the list 3601 of non-management job types (the special license target job types) and press a key 3604. By executing the operation, the job type that has been selected from the special license target job type list 3601 can be set as the management target job type.

When the user presses an enter button 3605 and if the application program has detected the user instruction input via the enter button 3605, the application program stores information about the job type set in the special license target job type list 3601 on the external memory of the SC 101 as the special license target job type. Accordingly, it is determined in step S3506 (FIG. 24) that the job corresponding to the job type, which has been set to the special license target job type list 3601, is the special license target job.

Accordingly, in the present exemplary embodiment having the above-described configuration, the MFP 102 can execute a specific job, which is determined as a job to be handled exempt from the license management and to which the license is unconditionally issued, regardless of the license-based management.

As described above, according to the present invention, the effect from the image forming apparatus on the environment can be efficiently and effectively controlled without degrading the user convenience such as reducing the number of image forming apparatuses connected to the system (suppressing the demerit against the user to a minimum) at the same time.

More specifically, each exemplary embodiment of the present invention can efficiently manage the energy consumption, such as the total amount of power consumed by or the total amount of CO₂ emitted by a plurality of image forming apparatuses included in the system.

As described above, the license has the valid term in the present invention. Accordingly, if the image forming apparatus becomes nonoperational without returning the license due to any trouble, the license can be given to other devices.

In the second exemplary embodiment, if the completion of the job is extremely delayed due to exhaustion of printing medium, such as printing paper, or due to a paper jam, the valid term can be extended before the license expires. With the above-described configuration, the second exemplary embodiment can prevent the expiry of license during execution of a job. Therefore, the second exemplary embodiment can effectively reduce the user's wait time during processing.

In the third exemplary embodiment described above, if the licenses for all the units (processing blocks) used in a job cannot be securely given by batch processing, the job is divided to issue the licenses therefor. With the above-described configuration, the third exemplary embodiment can reduce the user's wait time by executing the divided jobs. In addition, the third exemplary embodiment can reduce the possibility that the user is required to wait for a license to be given. Therefore, the third exemplary embodiment can prevent the degradation of the performance of the image forming apparatus. Furthermore, the third exemplary embodiment can improve the throughput of the entire system.

In the fourth exemplary embodiment of the present invention, the license is unconditionally issued to a specific job, which is determined as non-target job for the license management. With the above-described configuration, in the fourth exemplary embodiment, the MFP can execute the job regardless of the license-based management.

If a job that is to be printed when a failure occurs or a job that is required to be urgently printed in an emergency case is set as the specific job, the job can be executed without failing to print the job even if all the available licenses have been already issued.

With the above-described configuration, the present invention can suppress the user's wait time to a minimum even when the upper limit value of the index that may affect the environment, such as the power consumption or the CO₂ emission amount, is managed.

In addition, by controlling power to be supplied only to the processing blocks necessary for executing the input job and by not supplying power to the other processing units (processing blocks) that are unnecessary for executing the job as described above, the present invention can reduce the power consumed by the image forming apparatuses and the amount of CO₂ emitted by the image forming apparatuses. Accordingly, the present invention having the above-described configuration can efficiently manage and control the effect of the image forming apparatuses on the environment.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-107411 filed May 7, 2010, which is hereby incorporated by reference herein in its entirety.

What is claimed is:

1. An information processing apparatus configured to manage execution of a job by a plurality of image forming apparatuses, the information processing apparatus comprising:
a license issuance processing unit configured, according to a request for issuing a license for permitting the execution of the job, which is transmitted from the image forming apparatus in executing the job on the image forming apparatus, to issue the license to the image forming apparatus;
a management unit configured to store and manage an upper limit value of a number of licenses that can be issued to the total image forming apparatuses and the number of licenses that have been already issued; and
a license returning processing unit configured to subtract the number of already issued licenses, which is managed by the management unit, according to a request for returning the license transmitted from the image forming apparatus that has completed the job,
wherein the license issuance processing unit is configured to execute control for issuing the license if the number of already issued licenses does not exceed the upper limit value of the number of licenses that can be issued, and to execute control for issuing no license if the number of already issued licenses exceeds the upper limit value for the number of licenses that can be issued.

2. The information processing apparatus according to claim 1, wherein the license issuing processing unit is configured to issue the licenses in a quantity necessary for executing the job to the image forming apparatus.

3. The information processing apparatus according to claim 2, further comprising a determination unit configured to determine the upper limit value of the number of licenses according to an upper limit value of power consumption or an amount of carbon dioxide emitted in unit time by the total image forming apparatuses, wherein the number of licenses necessary for executing the job is a number of licenses determined according to the power consumption or the amount of carbon dioxide emitted in unit time by the image forming apparatus in executing the job.

4. The information processing apparatus according to claim 1, wherein each of the plurality of image forming apparatuses includes a plurality of processing blocks to which power can be supplied independently from one another and is configured, if the license has been given to execute the job, to supply power to the processing block used in executing the job.

5. The information processing apparatus according to claim 1, further comprising a job execution time prediction unit configured to predict time required for executing the job, wherein the license issuance processing unit is configured to issue a license having a valid term according to the time required for executing the job predicted by the job execution time prediction unit.

6. The information processing apparatus according to claim 5, wherein the license issuance processing unit is configured, according to a request for extending the valid term of the license, which is transmitted from the image forming apparatus if remaining time of the valid term of the license for executing the job has become less than specific time while the job is currently executed, to issue another license having a valid term which has been extended, to the image forming apparatus.

7. The information processing apparatus according to claim 5, further comprising an operation mode setting unit configured to set an operation mode of the image forming apparatus to be executed if the valid term of the license has elapsed.

8. The information processing apparatus according to claim 7, wherein the operation mode setting unit is configured to set either one of a first operation mode for continuing processing of the job even if the valid term of the license expires while executing the job, a second operation mode for continuing the processing of the job at a lower speed if the valid term of the license expires while executing the job, and a third operation mode for suspending the execution of the job if the valid term of the license expires while executing the job.

9. The information processing apparatus according to claim 8, wherein the license issued by the license issuance processing unit includes a license assigned to each processing block, for using each processing block in the image forming apparatus in executing the job on the image forming apparatus,
wherein the management unit is configured to store and manage the upper limit value of the number of licenses assigned to each processing block and the number of already issued licenses assigned to each processing block, and
wherein the license issuance processing unit is configured, when the license is issued, if at least one of the numbers of the already issued licenses assigned to each processing block may exceed the upper limit value of the number of the licenses assigned to each processing block, to execute control for dividing the job to be executed on the image forming apparatus into a plurality of steps and for issuing the license for each step.

10. The information processing apparatus according to claim 8, wherein the license issued by the license issuance processing unit includes a license assigned to each processing block for using each processing block in the image forming apparatus in executing the job on the image forming apparatus,
wherein the management unit is configured to store and manage the upper limit value of the number of licenses assigned to each processing block and the number of already issued licenses assigned to each processing block, and
wherein the license issuance processing unit is configured, when the license is issued, if the number of the already issued licenses assigned to each processing block may exceed the upper limit value of the number of the licenses assigned to each processing block, to execute adjustment processing for adjusting the upper limit value of the number of licenses assigned to each processing block within a range in which an upper limit value of the total number of licenses assigned to each processing block is not changed.

11. The information processing apparatus according to claim 10, wherein the license issuing processing unit is configured, when the license is issued, if, after the adjustment of the upper limit value is performed by the adjustment processing, at least one of the numbers of the already issued licenses assigned to each processing block may exceed the upper limit value of the number of the licenses assigned to each processing block, to execute control for dividing the job to be executed on the image forming apparatus into a plurality of steps and for issuing the license for each step.

12. The information processing apparatus according to claim 9, wherein each of the plurality of image forming apparatuses is configured, if a license for the step generated by dividing the job has been received, to execute the step and suspend an input of another license for a next step.

13. The information processing apparatus according to claim 9, wherein each of the plurality of image forming apparatuses is capable of supplying power to the plurality of processing blocks in the image forming apparatus independently from one another and is configured, if a license for the step generated by dividing the job has been received, to supply power to the processing block which has use permit according to the license for each processing block included in the license assigned to the divided step.

14. The information processing apparatus according to claim 1, further comprising a non-management job type setting unit configured to set a job type not to be subjected to license management, wherein the license issuance processing unit is configured, if a request for a license to a job corresponding to the job type set by the non-management job type setting unit has been received, to execute control for issuing the license regardless of whether the number of already issued licenses exceeds the upper limit value of the number of licenses that can be given.

15. A method for managing an image forming apparatus, which is executed by a computer configured to manage execution of a job in a plurality of image forming apparatuses, the method comprising:
issuing a license to the image forming apparatus according to a request for issuing a license for permitting the execution of the job, which is transmitted from the image forming apparatus in executing the job on the image forming apparatus;
storing and managing an upper limit value of a number of licenses that can be issued to the total image forming apparatuses and the number of licenses that have been already issued; and
returning the license by subtracting the managed number of already issued licenses according to a request for returning the license transmitted from the image forming apparatus that has completed the job, and
executing control for issuing the license if the number of already issued licenses does not exceed the upper limit value for the number of licenses that can be issued and executing control for issuing no license if the number of already issued licenses exceeds the upper limit value of the number of licenses that can be issued.

16. A computer-readable storage medium storing instructions which, when executed by a computer, cause the computer to function as the unit of the information processing apparatus according to claim 1.
